(19) United States
(12) Patent Application Publication
(10) Pub. No.: US 2004/0247937 A1
(43) Pub. Date: Dec. 9, 2004

(54) Organic electroluminescent devices with a doped co-host emitter

(76) Inventors: Chin-Hsin Chen, Taipei (TW); Tswen-Hsin Liu, Hsinchu Hsien (TW); Chung-Yeh Iou, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/721,586

(22) Filed: Nov. 24, 2003

(30) Foreign Application Priority Data
Jun. 3, 2003 (TW) 092115157

(51) Int. Cl. H05B 33/14

(52) U.S. Cl. 428/690; 428/917; 313/504

(57) ABSTRACT

An organic electroluminescent (EL) device comprising a pair of electrodes and at least one luminescent layer interposed between the pair of electrodes. The luminescent layer comprises a condensed polycyclic aromatic compound, an organic metal chelate and a luminescent dye.

The device according to the invention exhibits excellent resistance to current-induced quenching effect, so its luminance efficiency will not decrease as the input current density increases. The device also can emit light with high efficiency and high color saturation in red. The organic EL device is advantageously used in an organic EL display.

### FIELD OF THE INVENTION

The present invention relates to an organic electroluminescent (EL) device, and more specifically, to an organic EL device with a doped co-host emitter system so the device exhibits excellent resistance to current-induced quenching effect, which keeps the luminance efficiency from decreasing as the input current density increases and causes the device to emit light with high efficiency and high color saturation.

### BACKGROUND OF THE INVENTION

As the market demand for portable photoelectronic products such as laptop computers, digital cameras, personal digital assistants (PDAs), cellular phones and the like has significantly increased recently, display laboratories worldwide have actively begun to develop flat-panel displays. Conventional cathode ray tubes (CRTs) are bulky and poor in optical-electric conversion and therefore cannot meet the requirements for thin, lightweight and large-sized displays. Therefore, many new display technologies have emerged with the surge in demand for fashionable products, and the organic EL device is one flat-display technology that is notable and has considerable market potential in the field.

The structure of an organic EL device is a sandwich-type structure made by interposing one or more than one organic medium between two electrodes (an anode and a cathode). The anode is constructed of a high work function metal or a conductive compound, e.g., transparent metal oxides such as indium-tin-oxide (ITO), indium-zinc-oxide (IZO), SnO₂, ZnO and the like or thin film transistor (TFT) substrates such as low temperature poly-silicon (LTPS), amorphous silicon (a-Si), continuous grain silicon (CGS) and the like. The cathode is constructed of a low work function metal such as Au, Al, In, Mg, Ca and the like, LiF/Al, CsF/Al, alloys such as Mg:Ag and Ca:Al or a conductive compound, e.g., ITO, IZO, etc. To facilitate the efficient transmission of the light emitted, at least one of the two electrodes is transparent or semi-transparent. Depending on different conditions, the organic medium may comprise multiple layers wherein the thickness of each layer is not strictly limited and is usually between 5 nm to 500 nm.

Typically, an organic EL device is composed of three layers of organic molecules that are interposed between two electrodes. The three layers include an electron-transporting layer, a luminescent layer and a hole-transporting layer. A hole- or electron-injecting layer may be further added to reduce the driving voltage. Optionally, a hole- or electron-blocking layer may be added to improve the luminance efficiency. An organic EL device comprising four to six organic molecular layers is thus obtained. The electron-injecting layer usually consists of metal halides or nitrogen- and oxygen-containing metal chelates, e.g., KiF, 8-quinolinolato lithium (Liq) and the like. The hole-injecting layer usually consists of metal phthalocyanine derivatives, starburst polyamine derivatives, polyaniline derivatives (Y. Yang et al, Syn. Met., 1997, 87, 171), polyhalogenated aromatics, SiO₂ (Z. B. Deng et al, Appl. Phys. Lett., 1997, 74, 2227) or hole-transporting material doped oxides, e.g., copper (II) phthalocyanine (CuPc) (S. A. VanSlyke et al, Appl. Phy. Lett., 1996, 69, 2160), 4,4′,4″-tri(3-methyl-phenylphenylamino)triphenylamine (MTDATA) (Y. Shirota et al, App. Phys. Lett., 1994, 65, 807), ((N,N′-bis(m-tolyl)-1,1′-biphenyl-4,4′-diamine)+SbCl₆⁻ (TPD⁺SbCl₆⁻) (A. Yamamori et al, Appl. Phys. Lett., 1998, 72, 2147) and poly(3,4-ethylene-dioxythiophene)-poly(styrene) (PEDOT-PSS) (A. Elschner et al, Syn. Met., 2000, 111, 139). The electron-transporting layer can be composed of nitrogen- and oxygen-containing metal chelates (T. Sano et al, J. Mater. Chem., 2000, 10, 157), oxadiazole derivatives, perhalogenated polycyclic aromatic derivatives, aromatic cyclic ring- or heterocyclic ring-substituted silole derivatives, oligothiophene derivatives or benzimidazole derivatives, e.g., tris(8-quinolinolato) aluminum (Alq₃), biphenylyl-p-(t-butyl)phenyl-1,3,4-oxadiazole (PBD) (N. Johansson et al, Adv. Mater., 1998, 10, 1136), PyPySiPyPy (M. Uchida et al, Chem. Mater., 2001, 13, 2680), BMB-3T (T. Noda et al, Adv. Mater., 1999, 11, 283), PF-6P (Y. Sakamoto et al, J. Amer. Chem. Soc., 2000, 122, 1832), 1,3,5-tri(N-phenyl-benzimidazol-2-yl)benzene (TPBI) (Y. T. Tao et al, Appl. Phys. Lett., 2000, 77, 933), etc. The hole-transporting layer usually consists of charge-transporting materials for holes in organic photoconductive materials. The charge-transporting materials can be composed of triazole derivatives, oxadiazole derivatives, imidazole derivatives, phenylenediamine derivatives, starburst polyamine derivatives, spiro-linked molecule derivatives or arylamine derivatives, e.g., N,N′-bis(1-naphthyl)-N,N′-diphenyl-1,1′-biphenyl-4,4′ diamine (NPB) or its derivatives (Y. Sato et al, Syn. Met., 2000, 111, 25), PTDATA (Y. Shirota et al, Syn. Met., 2000, 111, 387) and spiro-mTTB (U. Bach et al, Adv. Mater., 2000, 12, 1060). The improvements in organic EL devices such as color, stability, efficiency and fabrication methods have been disclosed in U.S. Pat. Nos. 4,356,429; 4,539,507; 4,720,432; 4,885,211; 5,151,629; 5,150,006; 5,141,671; 5,073,446; 5,061,569; 5,059,862; 5,059,861; 5,047,687; 4,950,950; 4,769,292; 5,104,740; 5,227,252; 5,256,945; 5,069,975; 5,122,711; 5,366,811; 5,126,214; 5,142,343; 5,389,444; and 5,458,977.

Since the purposes of adjusting the luminescent color and increasing the luminance efficiency of the device can be easily achieved by selecting different luminescent guest emitters in the luminescent layer, the organic EL devices posses considerable potential in the production of full-color displays. The conventional way is to prepare a bi-component (host and guest emitters) luminescent layer (U.S. Pat. No. 4,769,292) that utilizes the excitation energy generated by the host emitter driven by current to excite the guest emitter (or the dopant) having high luminance efficiency and lower bandgap energy to emit different colors of light. While the organic electroluminescent device prepared by using conventional bi-component luminescent systems generally raises the luminance efficiency significantly, the extent to which the luminance efficiency rises usually decreases as the driving current density increases. This occurs because of the quenching caused by the internal unbalanced transporting charges. Such a quenching mechanism resulting from the unbalanced transport of the internal carriers will cause the luminance efficiency of the organic EL device expressed in terms of cd/A to drop as the current density rises and will further cause the control of the light output of an organic EL device to become very difficult. In particular, when an organic EL device is used in a passive driven module, the driving circuit it employs is a scan type electrode. The transient luminance of each pixel can be higher than 5000 (cd/m²), and the transient luminance increases with the requirement on the resolution of a flat-panel display. That is, the relative driving current density must be very high. If a sever charge quenching mechanism occurs in this situation, it will cause the engineer who designs the integrated circuit to encounter problems in the control of the light output and the balance of the color of the organic EL device. This is greatly disadvantageous to the production of flat-panel displays.

In addition, sharp color is an essential requirement for the production of high-level full-color displays. Organic luminescent dyes do not inherently have sharp and highly saturated luminescent colors due to the diversity of the luminophor and highly conjugated chains and the complexity of the luminescent environment. Thus, how to create an efficient luminescent environment is also a problem that needs to be solved.

To eliminate the drawbacks described above and further improve the performance of doped organic electroluminescent devices (OLED), Sanyo Electric Co., Japan, in 1999, first proposed an idea of adding a dopant assist in addition to the host and guest emitters to the luminescent layer to form a tri-component luminescent system (Japanese Patent Application Laid-Open No. 2000-164362 (P2000-164362A)) (Y. Hamada et al, Appl. Phys. Lett., 1999, 75, 1682). A dopant assist is defined as a condensed polycyclic aromatic compound having a two-way carrier transporting property. The dopant assist does not participate in emitting light per se but functions to transfer the excitation energy of the host emitter to the guest emitter. The bandgap energy of the dopant assist must therefore be between those of the host and the guest emitters in order to achieve high energy-transfer efficiency. Sanyo asserts that the organic EL devices prepared according to said invention have the advantages of stable light emission and long operational life.

To solve the problem of the internal quenching of the device, Sanyo further added a polyamine hole-capturing dopant in the tri-component luminescent layer to form a tetra-component system (T. K. Hatwar et al, Proc. EL'00, Hamamatsu, Japan, Dec. 2000, p. 31).

Chiba, Japan also submitted a Patent application, US 2002/0048688 A1, relating to a tri-component luminescent layer. The luminescent system comprises at least an anthracene derivative and an electron-transporting material, wherein the anthracene is a compound formed by condensing three benzene rings. Chiba asserts that the organic EL device prepared according to said invention has high heat resistance, long operation life and high luminance efficiency.

However, in the prior art described above, the combination of the luminescent layers cannot free the organic EL devices from the luminance efficiency decaying mechanism caused by high drive current density. To solve this problem, the present invention proposes an organic EL device with a doped co-host emitter.

### SUMMARY OF THE INVENTION

The main objective of the present invention is to provide an organic EL device with a doped co-host emitter, which has high luminance efficiency, low driving voltage and high color saturation.

A further objective is to provide a high performance organic EL device that effectively inhibits the internal decay of the luminescence caused by unbalanced charges. Inhibiting the internal decay in a high performance organic EL device keeps the luminance efficiency (cd/A) from reducing as the input current density increases and allows the device to emit light stably over long-term operation.

An organic electroluminescent device according to the present invention comprises a pair of electrodes and at least one luminescent layer consisting of organic materials between the pair of electrodes. The luminescent layer comprises a condensed polycyclic aromatic compound, an organic metal chelate and a luminescent dye. The condensed polycyclic aromatic compound can be substituted or unsubstituted, with the proviso that the substituting group is limited to C₁-C₃alkyl, C₂-C₃alkenyl, C₁-C₃alkoxy or cyano groups.

The organic electroluminescent device prepared according to the present invention has many excellent properties. The most unique property is that the current-induced luminance quenching effect in the device caused by excess charge can be eliminated. In this connection, the prior art neither mentioned nor provided any solution for solving the problem.

The simplest way to determine whether the quenching caused by the charges in an organic EL device is serious or not is to observe the profile diagram of the luminance efficiency (cd/A) against current density (mA/cm²) of the device. When charge quenching is present in the device, the amount of internal unbalanced charges will increase as the input current density increases and result in a declining trend in the profile of the luminance efficiency against current density (see FIG. 18 of Comparative Example 2).

In contrast, when a device is capable of efficiently inhibiting internal charge quenching, the luminance efficiency will not be affected by the input current density and will remain constant. Therefore, the profile of the luminance efficiency against current density will be flat (see FIG. 3 of Example 2).

The present invention is distinguished from the prior art by preparing an organic EL device in which internal current-induced quenching is totally inhibited and the luminance efficiency (cd/A) against current density profile is flat. The present invention therefore allows the organic EL device to have improved luminance efficiency over a wide range of drive current density conditions and, in the case of red dopants, it also increases color saturation.

The key feature of the present invention is the incorporation of condensed polycyclic aromatic compounds. The most suitable condensed polycyclic aromatic compounds according to the present invention are unsubstituted. Some substituted condensed polycyclic aromatic compounds can also be used, the sizes of the substituting groups, however, must be limited. In principle, the size of the substituting group must be small, e.g., C₁-C₃alkyl, C₂-C₃alkenyl, C₁-C₃alkoxy or cyano groups. According to the Examples of the present invention, an oversized substituting group on the condensed polycyclic aromatic compound, e.g., iso-butyl having four carbon atoms, will hinder the intermolecular hopping process of the charged carriers, reduce the mobility of the carriers and further lead to the internal charge quenching effect.

As used herein, the term “co-host emitter” refers to an emitter comprising a condensed polycyclic aromatic compound and an organic metal chelate.

As used herein, the term “doped co-host emitter” refers to an emitter as described above which is doped with a luminescent dye.

As used herein, the term “condensed polycyclic aromatic compound” refers to a polycyclic aromatic compound composed of one or more than one benzene ring or condensed ring, wherein the condensed ring uses a benzene ring as a unit and is formed by condensing 2 to 10 benzene rings. The benzene ring or condensed ring of the condensed polycyclic aromatic compound can be substituted or unsubstituted, with the proviso that the substituting group is limited to C₁-C₃alkyl, C₂-C₃alkenyl, C₁-C₃alkoxy or cyano groups.

As used herein, the term “organic metal chelate” refers to a chelate comprising a central metallic ion and one or more ligands containing one or more than one nitrogen atom. The abbreviation “q” used for referring to some organic metal chelates represents the ligand “quinolinolate.”

It is another feature of the present invention that the red luminescent dye doped co-host emitter provides higher color saturation expressed in terms of 1931 CIE x,y color coordinates than that of the same dye doped in the single host emitter medium.

### BRIEF DESCRIPTION OF THE DRAWINGS

Further benefits and advantages of the present invention will become apparent after a careful reading of the detailed description with appropriate reference to the accompanying drawings.

FIG. 1 is a diagram of an embodiment of an organic electroluminescent device in accordance with the present invention.

FIG. 2 is a graph of the luminance efficiency against current density of a rubrene/Alq₃ (40/60) co-host doped with 2 wt-% of DCJTB in an organic EL device with a single organic layer.

FIG. 3 is a graph of the luminance efficiency against current density of a rubrene/Alq₃ (60/40) co-host doped with 2 wt-% of DCJTB in an organic EL device with multiple organic layers.

FIG. 4 is a graph of the luminance efficiency against current density of a perylene/Alq₃ (20/80) co-host doped with 2 wt-% of DCJTB in an organic EL device with multiple organic layers.

FIG. 5 is a graph of the luminance efficiency against current density of a pyrene/Alq₃ (20/80) co-host doped with 2 wt-% of DCJTB in an organic EL device with multiple organic layers.

FIG. 6 is a graph of the luminance efficiency against current density of a DPA/Alq₃ (40/60) co-host doped with 2 wt-% of DCJTB in an organic EL device with multiple organic layers.

FIG. 7 is a graph of the luminance efficiency against current density of an ADN/Alq₃ (80/20) co-host doped with 2 wt-% of DCJTB in an organic EL device with multiple organic layers.

FIG. 8 is a graph of the luminance efficiency against current density of a MADN/Alq₃ (40/60) co-host doped with 2 wt-% of DCJTB in an organic EL device with multiple organic layers.

FIG. 9 is a graph of the luminance efficiency against current density of an EADN/Alq₃ (80/20) co-host doped with 2 wt-% of DCJTB in an organic EL device with multiple organic layers.

FIG. 10 is a graph of the luminance efficiency against current density of a rubrene/Gaq₃ (60/40) co-host doped with 2 wt-% of DCJTB in an organic EL device with multiple organic layers.

FIG. 11 is a graph of the luminance efficiency against current density of a rubrene/inq₃ (60/40) co-host doped with 2 wt-% of DCJTB in an organic EL device with multiple organic layers.

FIG. 12 is a graph of the luminance efficiency against current density of a rubrene/BeBq₂ (60/40) co-host doped with 2 wt-% of DCJTB in an organic EL device with multiple organic layers.

FIG. 13 is a graph of the luminance efficiency against current density of a rubrene/Almq₃ (60/40) co-host doped with 2 wt-% of DCJTB in an organic EL device with multiple organic layers.

FIG. 14 is a graph of the luminance efficiency against current density of an ADN/Alq₃ (60/40) co-host doped with 1 wt-% of C545T in an organic EL device with multiple organic layers.

FIG. 15 is a graph of the luminance efficiency against current density of an ADN/BAlq co-host (60/40) doped with 1 wt-% of C545T in an organic EL device with multiple organic layers.

FIG. 16 is a graph of the luminance efficiency against current density of an ADN/NAlq₃ (80/20) co-host doped with 1 wt-% of TBP in an organic EL device with multiple organic layers.

FIG. 17 is a graph of the luminance efficiency against current density of an Alq₃ single-host doped with DCJTB in a (100):2 concentration in an organic EL device with multiple organic layers.

FIG. 18 is a graph of the luminance efficiency against current density of an ADN single-host doped with DCJTB in a (100):2 concentration in an organic EL device with multiple organic layers.

FIG. 19 is a graph of the luminance efficiency against current density of a non-doped rubrene/Alq₃ (60/40) co-host in an organic EL device with multiple organic layers.

FIG. 20 is a graph of the luminance efficiency against current density of a NPB/Alq₃ (50/50) co-host doped with 2 wt-% of DCJTB in an organic EL device with multiple organic layers.

FIG. 21 is a graph of the luminance efficiency against current density of a rubrene/NPB (50/50) co-host doped with 2 wt-% of DCJTB in an organic EL device with multiple organic layers.

FIG. 22 is a graph of the hole mobility against (electric field)^{1/2} of rubrene.

FIG. 23 is a graph of the hole mobility against (electric field)^{1/2} of TTB-Rb.

FIG. 24 is a graph of the luminance efficiency against current density of a TTB-Rb/Alq₃ (60/40) co-host doped with 2 wt-% of DCJTB in an organic EL device with multiple organic layers.

FIG. 25 is a graph of the luminance efficiency against current density of a TBP/Alq₃ (20/80) co-host doped with 2 wt-% of DCJTB in an organic EL device with multiple organic layers.

FIG. 26 is a graph of the luminance efficiency against current density of a TB-ADN/Alq₃ (60/40) co-host doped with 2 wt-% of DCJTB in an organic EL device with multiple organic layers.

FIG. 27 is a graph of the luminance efficiency against current density of a TTB-ADN/Alq₃ (60/40) co-host doped with 2 wt-% of DCJTB in an organic EL device with multiple organic layers.

### DETAILED DESCRIPTION OF THE INVENTION

An organic EL device with a single organic layer according to the present invention only comprises a tri-component luminescent layer between an anode and a cathode. This simplest form shows that the doped co-host emitter according to the present invention has an excellent two-way carrier transporting property and, if necessary, can be used alone and does not need to insert further organic media between the electrodes.

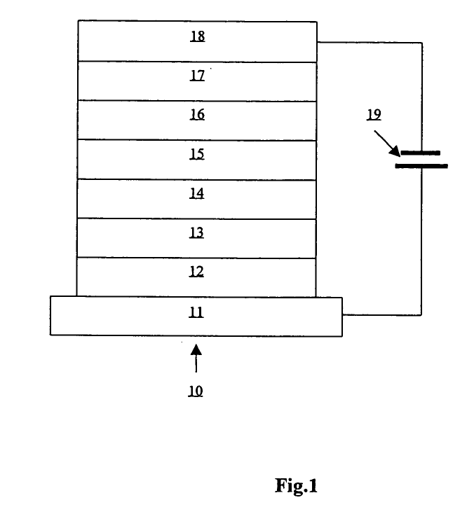

An organic EL device with multiple organic layers (10) in accordance with the invention is schematically illustrated in FIG. 1. The organic EL device 10 comprises a transparent substrate 11, an anode layer 12, a hole-injecting layer 13, a hole-transporting layer 14, a luminescent layer 15, an electron-transporting layer 16, an electron-injecting layer 17 and a cathode layer 18.

The transparent substrate 11 is glass or plastic. The anode layer 12 is transparent and electroconductive and is deposited on the substrate 11. A hole-injecting material is deposited on the anode layer 12 to form the hole-injecting layer 13. Subsequently, a hole-transporting material is deposited on the hole-injecting layer 13 to form a hole-transporting layer 14. The organic luminescent layer 15 made of two host luminescent materials containing a dopant is deposited on the layer 14. The electron-transporting layer 16 made of electron-transporting materials is deposited on the surface of the organic luminescent layer 15. Next, the electron-injecting layer 17 made of electron-injecting materials is deposited on the surface of the electron-transporting layer 16, and the cathode layer 18 made of metal is deposited on the surface of the electron-injecting layer 17 to form a cathode. The anode layer 12 is a p-type contact whereas the cathode layer 18 is an n-type contact.

A power source 19 with a negative end and a positive end provides an electric potential to the organic EL device 10. The cathode layer 18 of the device 10 is connected to the negative end and the anode layer 12 is connected to the positive end of the power source 19. When a potential is applied between the anode layer 12 and the cathode layer 18 by the power source 19, electrons will be ejected from the n-type contact (cathode layer 18) and will pass into the organic luminescent layer 15 through the electron-injecting layer 17 and organic electron-transporting layer 16. Simultaneously, holes will be ejected from the p-type contact (anode layer 12) and will pass into the organic luminescent layer 15 through the organic hole-injecting layer 13 and organic hole-transporting layer 14. When electrons and holes recombined in the organic luminescent layer 15, photon are emitted. The present invention provides a doped co-host emitter in the luminescent layer of an organic EL device. The luminescent layer according to the present invention comprises a condensed polycyclic aromatic compound, an organic metal chelate and a luminescent dye.

The condensed polycyclic aromatic compound used according to the present invention has a chemical structure composed of one or more than one benzene ring or condensed ring, wherein the condensed ring uses a benzene ring as a unit and is formed by condensing 2 to 10 benzene rings. The benzene ring or condensed ring of the condensed polycyclic aromatic compound is substituted or unsubstituted, with the proviso that the substituting group is limited to C₁-C₃alkyl, C₂-C₃alkenyl, C₁-C₃alkoxy or cyano groups.

The weight ratio of condensed polycyclic aromatic compound to organic metal chelate in the luminescent layer is from 20:80 to 80:20.

In an embodiment of the present invention, the condensed polycyclic aromatic compound in the luminescent layer is of the formula

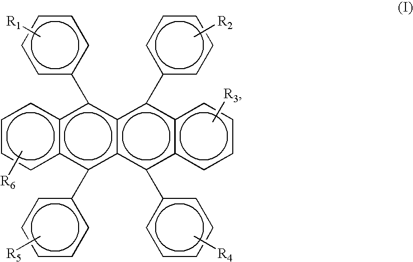

wherein R₁ to R₆ independently represent hydrogen, C₁-C₃alkyl, C₂-C₃alkenyl, C₁-C₃alkoxy or cyano groups.

In another embodiment of the present invention, the condensed polycyclic aromatic compound in the luminescent layer is of the formula

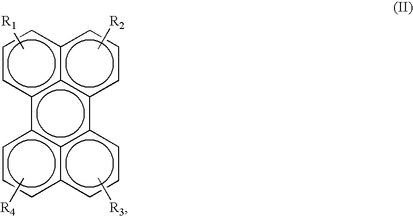

wherein R₁ to R₄ independently represent hydrogen, C₁-C₃alkyl, C₂-C₃alkenyl, C₁-C₃alkoxy or cyano groups.

In yet another embodiment of the present invention, the condensed polycyclic aromatic compound in the luminescent layer is of the formula

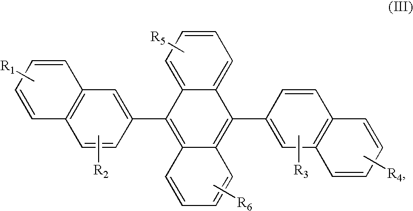

wherein R₁ to R₆ independently represent hydrogen, C₁-C₃alkyl, C₂-C₃alkenyl, C₁-C₃alkoxy or cyano groups.

In a further embodiment of the present invention, the condensed polycyclic aromatic compound in the luminescent layer is of the formula

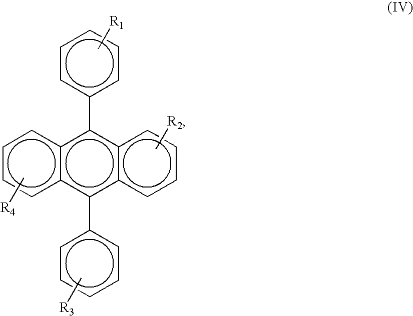

wherein R₁ to R₄ independently represent hydrogen, C₁-C₃alkyl, C₂-C₃alkenyl, C₁-C₃alkoxy or cyano groups.

In a still further embodiment of the present invention, the condensed polycyclic aromatic compound in the luminescent layer is of the formula

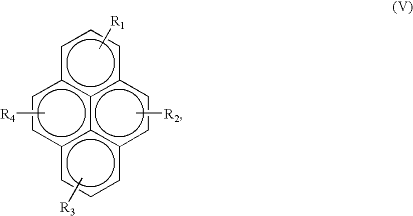

wherein R₁ to R₄ independently represent hydrogen, C₁-C₃alkyl, C₂-C₃alkenyl, C₁-C₃alkoxy or cyano groups.

The condensed polycyclic aromatic compound in the luminescent layer is selected from, but not limited to, the following materials:

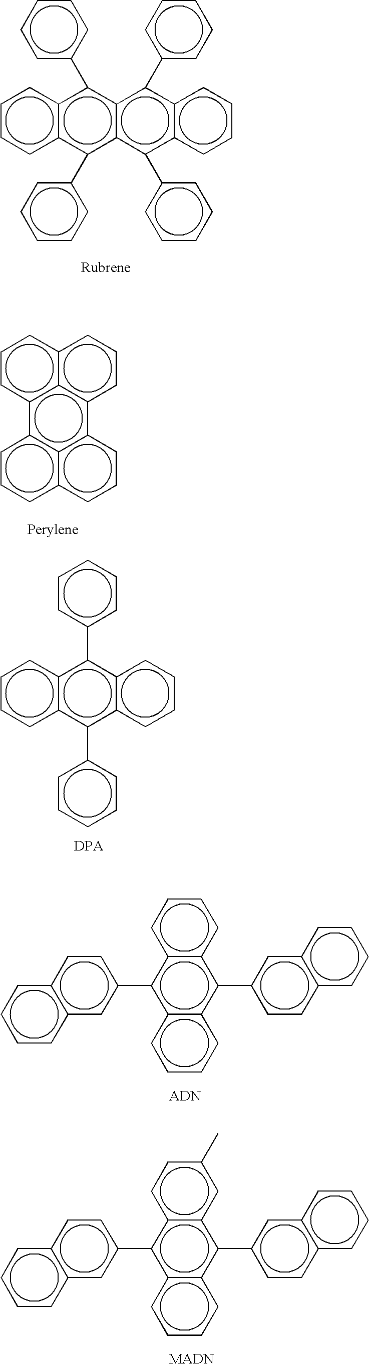

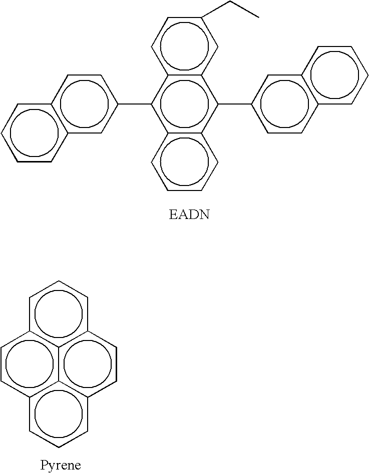

The organic metal chelate used according to the present invention comprises a ligand containing one or more than one nitrogen atom and is of the general formula

M-XₘYₙ (VI),

wherein M signifies a metal with a valence of 2 or 3; X signifies a ligand containing one or more than one nitrogen atom; Y signifies a nitrogen-free ligand; m is 2 or 3,n is 0, 1 or 2, and m+n is 2 or 3.

The ligand X of the organic metal chelate in the luminescent layer is of any one of the formulae

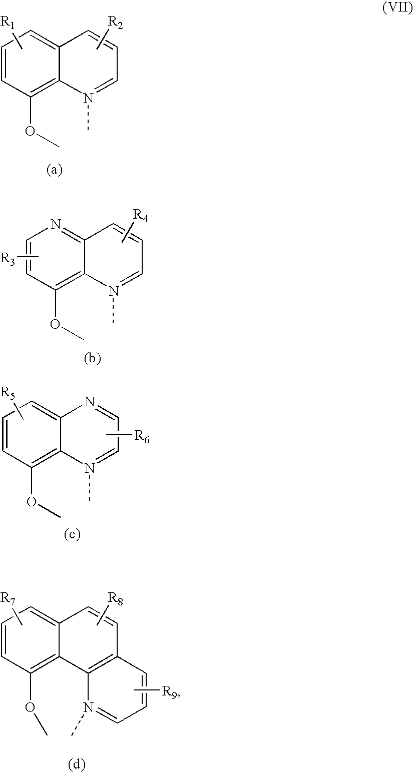

wherein R₁ to R₉ independently represent hydrogen or any substituting groups.

The following is a partial list of the examples of the organic metal chelates that meet the requirements for the invention:

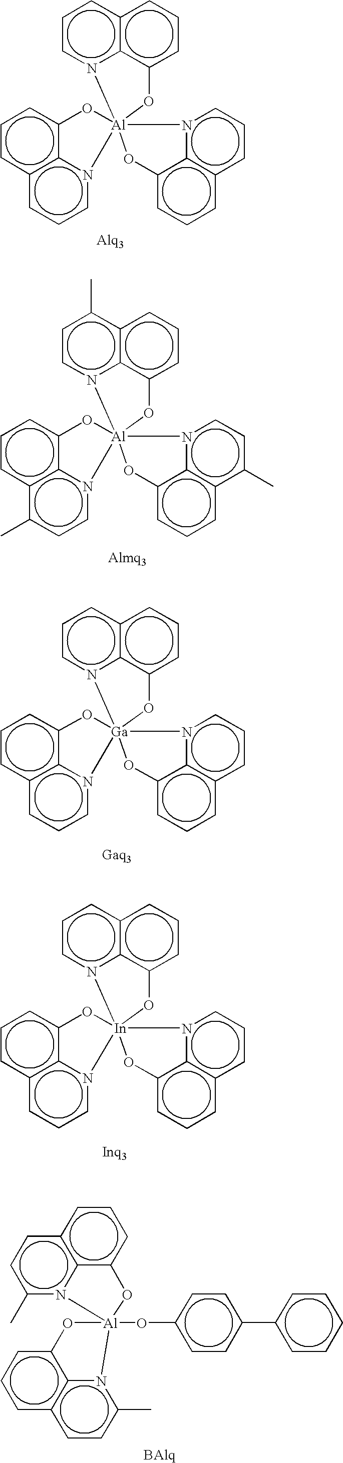

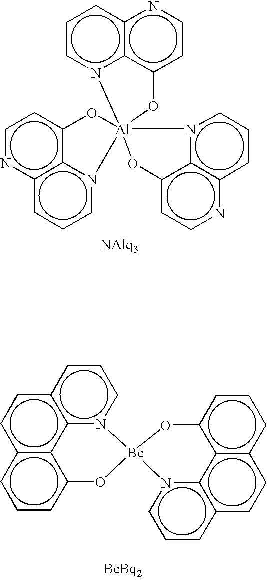

The chemical structure of the luminescent dye used according to the present invention is of formula 1, 2 or 3,

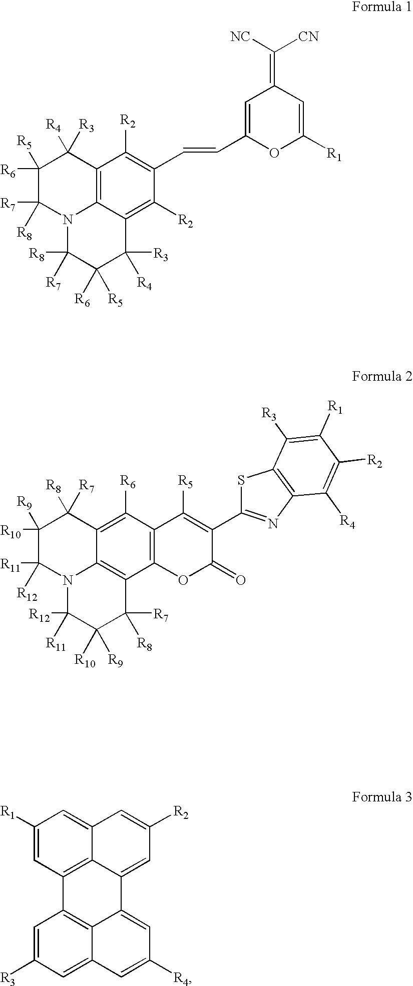

wherein R₁ to R₁₂ independently represent hydrogen or any substituting groups.

The luminance range of the luminescent dye in the luminescent layer is between 450 nm and 700 nm. The following is a partial list of the examples of the luminescent dye dopants that meet the requirements for the invention to emit red, green and blue light.

For the material emitting red light, the examples are DCM and DCJTB derivatives:

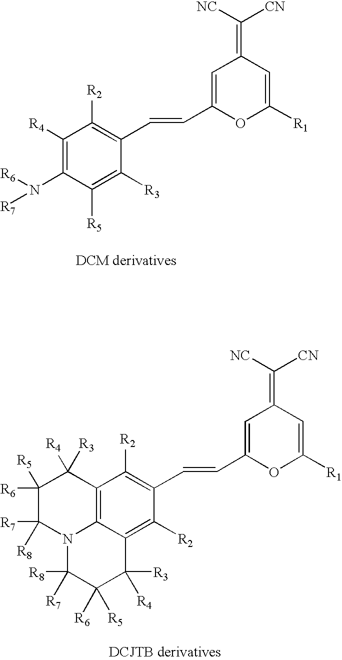

wherein, R₁ to R₈ independently represent hydrogen or any substituting groups. The representative example is DCJTB:

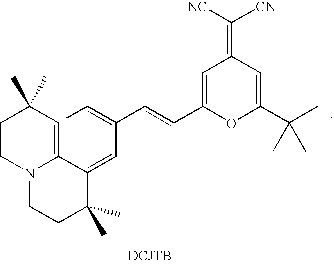

For the material emitting green light, the examples are coumarine, C545T and quinacridone derivatives:

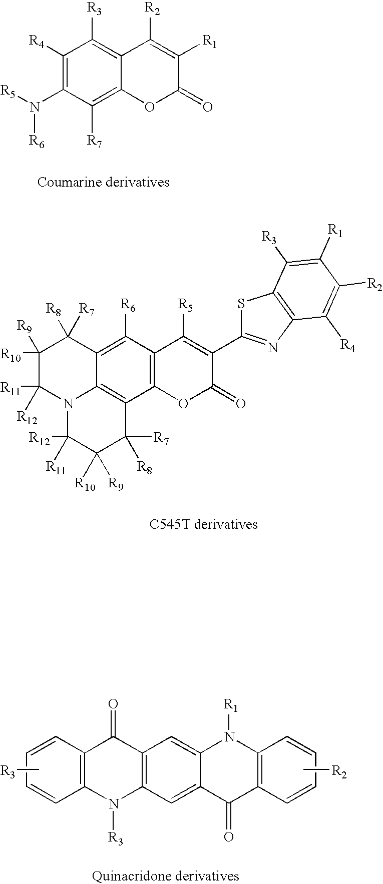

wherein, R₁ to R₁₂ independently represent hydrogen or any substituting groups. The representative example is C545T:

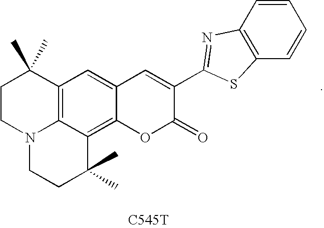

For the material emitting blue light, the examples are perylene and DSA-ph derivatives:

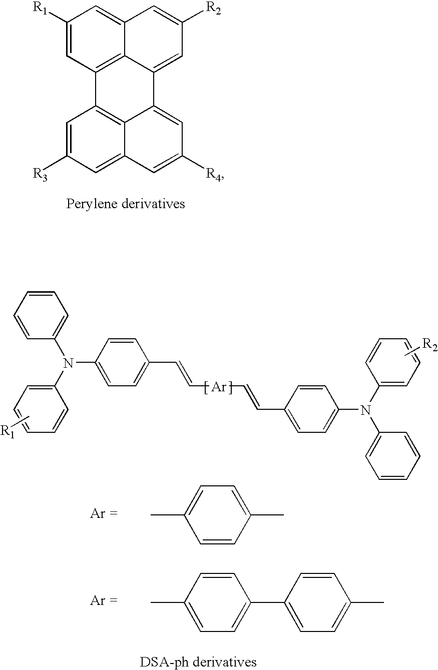

wherein, R₁ to R₄ independently represent hydrogen or any substituting groups. The representative example is TBP:

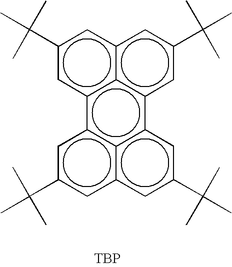

### EXAMPLES

The invention and its advantages are further illustrated in the following examples in conjunction with the figures. Examples 1 to 8 are directed to the condensed polycyclic aromatic compound in the luminescent layer.

### Example 1

### Fabrication and Measurement of an Organic EL Device With a Single Organic Layer

The structure of the device in this Example is the simplest form of the present invention, which only comprises a tri-component luminescent layer between an anode and a cathode. This Example proves that the doped co-host emitter according to the present invention has an excellent two-way carrier transporting property and, if necessary, can be used alone and does not need to insert further organic media between the electrodes. In the luminescent layer, the condensed polycyclic aromatic compound is rubrene based on an unsubstituted tetra-condensed ring in combination with four unsubstituted benzene rings; the organic metal chelate is an organic chelate of aluminum, tris(8-quinolinolato) aluminum (Alq₃), in which the ligand contains one nitrogen atom; and the luminescent dye is DCJTB emitting red light at 624 nm. The device is prepared as follows:

(a) An ITO coated glass was sequentially treated by a commercial detergent, rinsed in deionized water, degreased in an organic solvent and dried. After the surface was treated with a plasma processor, the ITO glass was placed under a high vacuum to undergo a thin film evaporation deposition.

(b) A co-host emitter, rubrene/Alq₃, and a guest emitter, DCJTB, were co-deposited by evaporation onto the surface of the ITO glass to form a luminescent layer having a thickness of 100 nm. The ratio of rubrene and Alq₃ in the co-host emitter is 60/40, and the weight ratio of the guest emitter DCJTB to the co-host emitter is 2 wt-%.

(c) A Mg:Ag alloy was deposited onto Alq₃ by evaporation from a tantalum boat to form a cathode with a thickness of about 200 nm.

(d) A current was passed through the organic EL device obtained, and the luminance and luminance efficiency were measured by a photocolorimeter.

The features of the EL device when it was driven by a current source at 20 mA/cm² are tabulated as follows:

| | |
|---|---|
| Driving voltage (volts) | 9.2 |
| Luminance (cd/m²) | 522 |
| Luminance efficiency (cd/A) | 2.8 |
| CIE coordinate x | 0.66 |
| CIE coordinate y | 0.34 |
| Peak wavelength (nm) | 628 |
| Width of peak (nm) | 80 |

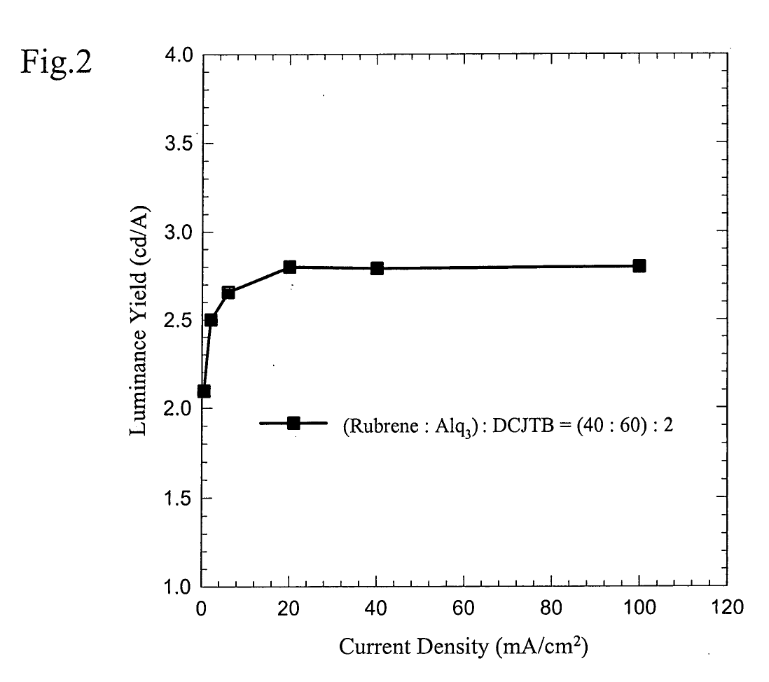

With reference to FIG. 2, the luminance efficiency of the device is flat when the current density is greater than 20 mA/cm². This demonstrates that the device is able to effectively inhibit the internal quenching effect caused by high drive current density. The luminance efficiency does not drop as the input current density rises.

### Example 2

### Fabrication and Measurement of an Organic EL Device With Multiple Organic Layers

To further enhance the performance of the device, in addition to the luminescent layer, organic media such as a hole-injecting layer, a hole-transporting layer and an electron-transporting layer can be inserted between the electrodes. The host and guest luminescent materials in the luminescent layer are the same as those used in Example 1. The process for the preparation of such a multi-layer device follows:

(a) An ITO coated glass was sequentially treated by a commercial detergent, rinsed in deionized water, degreased in an organic solvent and dried. After the surface was treated with a plasma processor, the ITO glass was placed under a high vacuum to undergo a thin film evaporation deposition.

(b) The hole-injecting layer: CHF₃ was treated by a plasma processor and the hole-injecting material (CFₓ)ₙ was coated at a thickness of about 3 nm onto the surface of the glass as the hole-injecting layer.

(c) The hole-transporting layer: NPB having a thickness of 120 nm was deposited onto the (CFₓ)ₙ layer by evaporation from a tantalum boat as the hole-transporting layer.

(d) A co-host emitter, rubrene/Alq₃, and a guest emitter, DCJTB, were co-deposited by evaporation onto the surface of the NPB layer to form a luminescent layer having a thickness of 30 nm. The ratio of the rubrene and Alq₃ in the co-host emitter is 60/40, and the weight ratio of the guest emitter DCJTB to the co-host emitter is 2 wt-%.

(e) Alq₃ was deposited at a thickness of 55 nm onto the luminescent layer by evaporation from a tantalum boat to form an electron-transporting layer.

(f) LiF was deposited at a thickness of 1 nm onto the electron-transporting layer of Alq₃ by evaporation from a tantalum boat. Aluminum was then deposited by evaporation on top of the LiF layer to form a complex cathode with a thickness of about 200 nm.

(g) A current was passed through the organic EL device obtained, and the luminance and luminance efficiency were measured by a photocolorimeter.

The features of the EL device when it was driven by a current source at 20 mA/cm² are tabulated as follows:

| | |
|---|---|
| Driving voltage (volts) | 6.8 |
| Luminance (cd/m²) | 888 |
| Luminance efficiency (cd/A) | 4.5 |
| CIE coordinate x | 0.65 |
| CIE coordinate y | 0.35 |
| Peak wavelength (nm) | 628 |
| Width of peak (nm) | 80 |

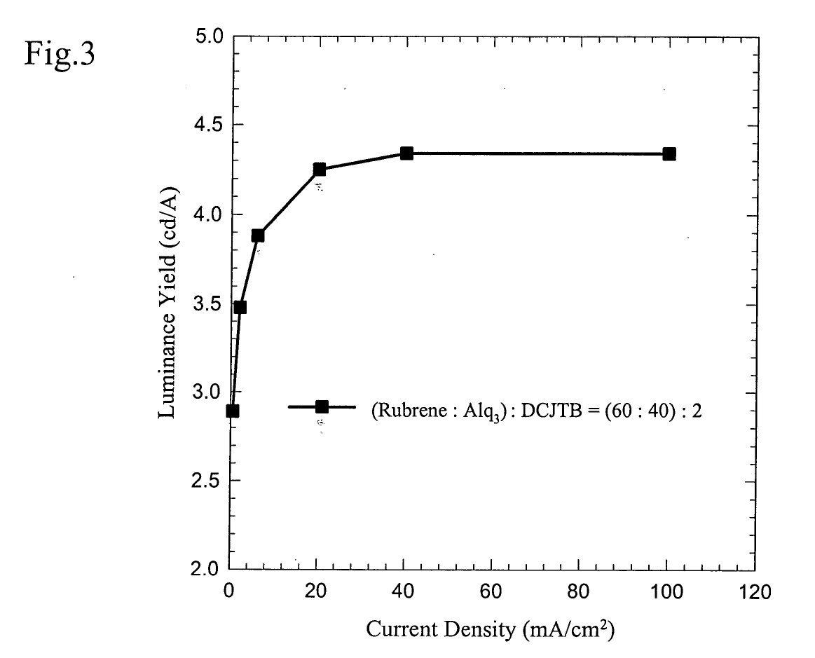

With reference to FIG. 3, the luminance efficiency of the device is flat when the current density is greater than 40 mA/cm². This demonstrates that the device is able to effectively inhibit the internal quenching effect caused by high drive current density. The luminance efficiency does not drop as the input current density rises.

### Examples 3 to 5

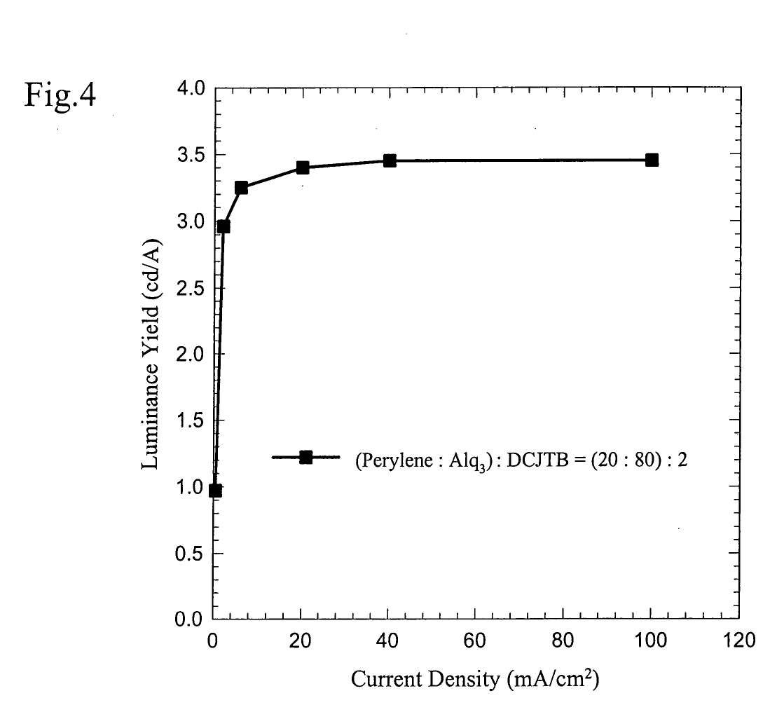

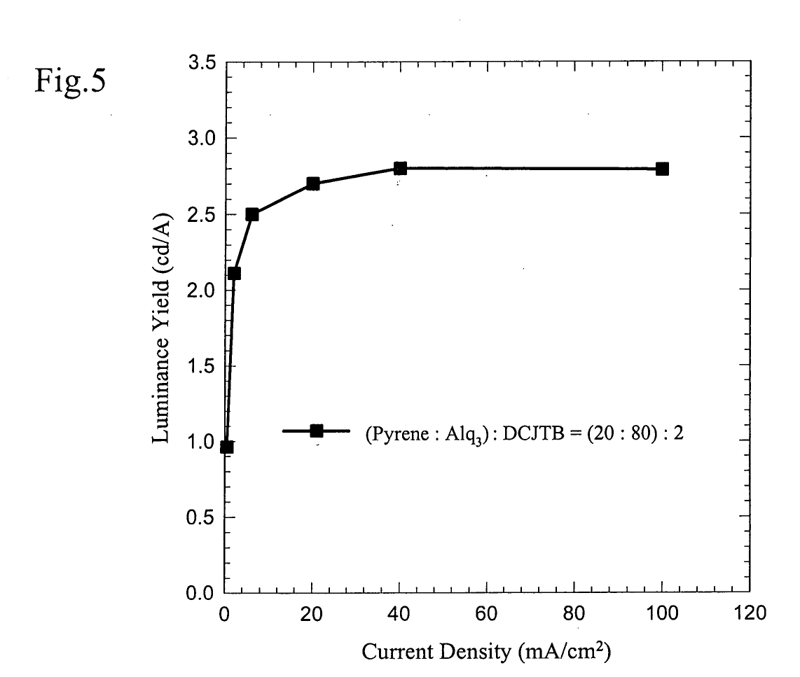

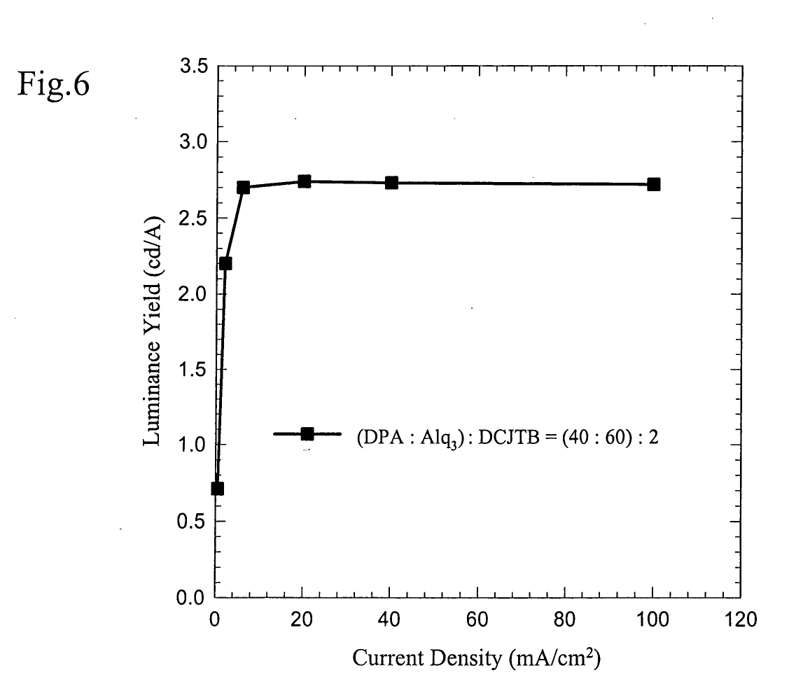

The structures and preparation procedures of the organic EL devices were the same as those in Example 2, except that the rubrene based on an unsubstituted tetra-condensed ring was replaced by DPA based on an unsubstituted tri-condensed ring, pyrene based on a unsubstituted tetra-condensed ring and perylene based on an unsubstituted penta-condensed ring in Examples 3, 4 and 5, respectively. The compositions of the luminescent layers are shown in table 1-1, the performances of the devices are shown in table 1-2, and the luminance efficiency trends of the devices when subjected to increasing current density are shown in FIGS. 4, 5 and 6, respectively.

The results of these Examples clearly show that all the devices have the advantages of flat luminance efficiency as current density increases, high luminance efficiency and high color saturation with CIE ranges from x=0.64-0.67 and y=0.35. These Examples demonstrate that the condensed polycyclic aromatic compound of the invention can be implemented with unsubstituted condensed polycyclic aromatic compounds.

### Examples 6 to 8

The structures and preparation procedures of the organic EL devices were the same as those in Example 2, except that the rubrene based on a unsubstituted tetra-condensed ring was replaced by ADN, MADN and EDAN based on unsubstituted or substituted tri-condensed rings in Examples 6, 7 and 8, respectively. The differences among the three compounds are that MADN has one more methyl group and EADN has one more ethyl group on the tri-condensed ring than ADN.

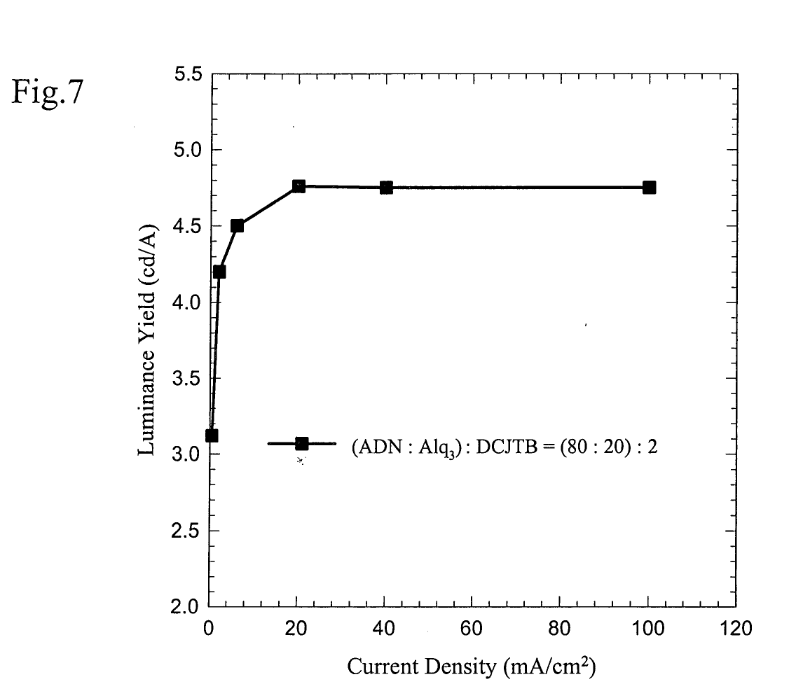

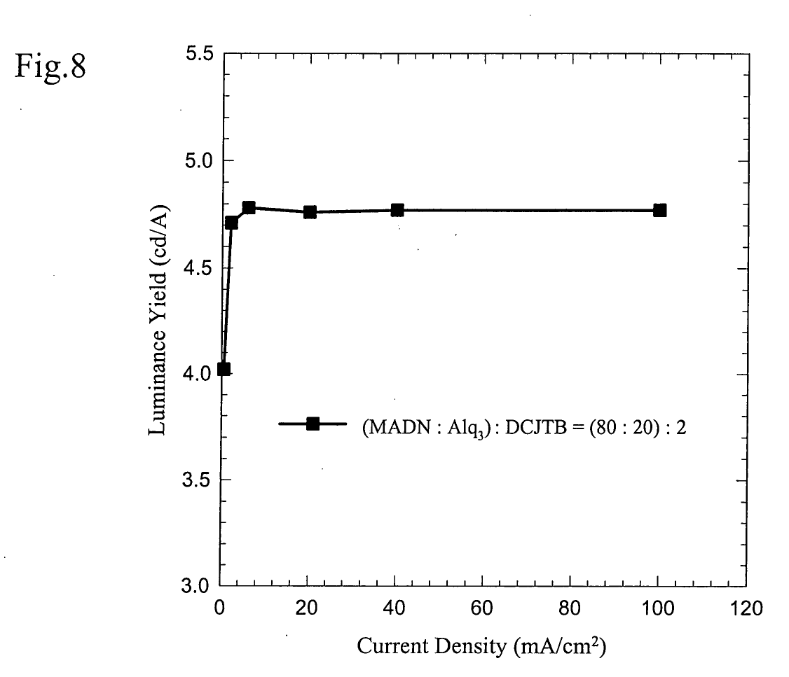

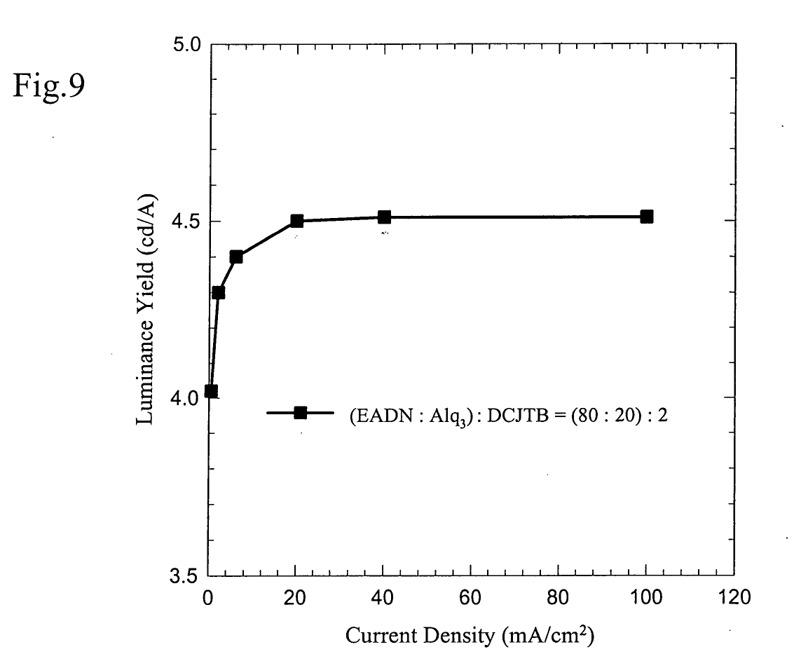

The compositions of the luminescent layers are shown in table 1-1, the performances are shown in table 1-2, and the luminance efficiency trends of the devices as the current density increases are shown in FIGS. 7, 8 and 9, respectively.

The results of these Examples clearly show that all the devices have the advantages of flat luminance efficiency as current density increases, high luminance efficiency and high color saturation with CIE x=0.64 and y=0.35. These Examples demonstrate that the condensed polycyclic aromatic compound of the invention can be selected from, in addition to unsubstituted condensed polycyclic aromatic compounds, substituted compounds having small-sized substituting groups.

Examples 9 to 15 are directed to the organic metal chelate and the luminescent dye.

### Examples 9 to 11

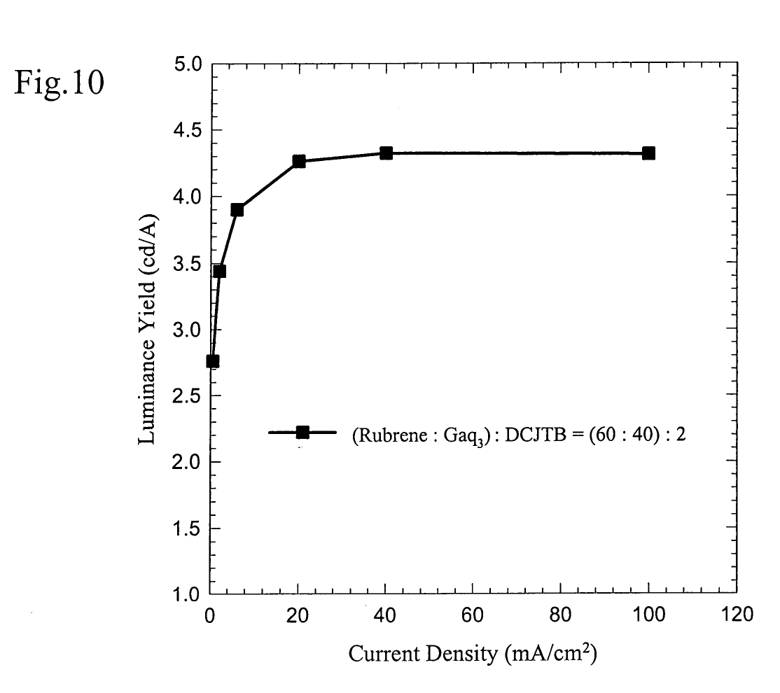

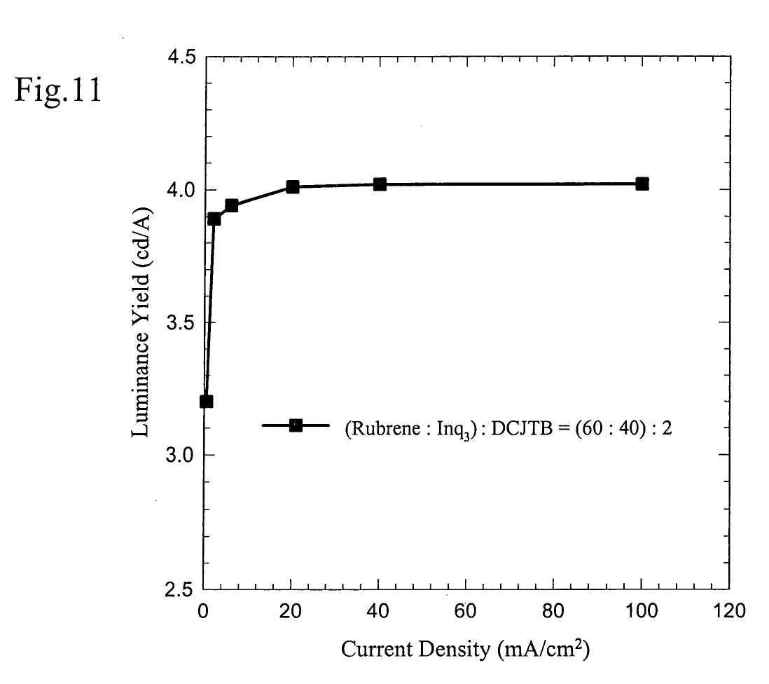

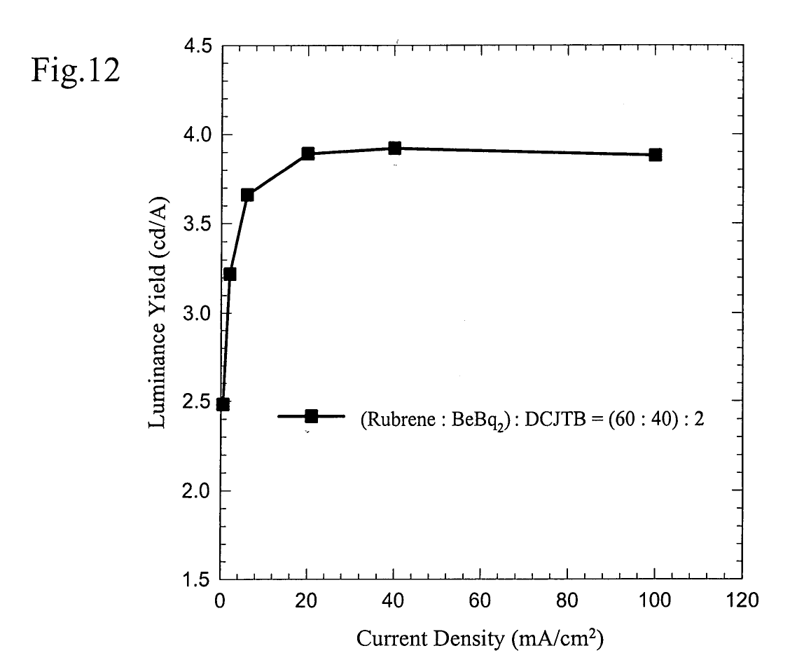

The structures and preparation procedures of the organic EL devices were the same as those in Example 2, except that the central metallic ion of the organic metal chelate in the luminescent layer was gallium and indium with a valence of +3 and beryllium with a valence of +2 in Examples 9, 10 and 11, respectively, and the ligand was a benzoquinolinol ligand in each example. The compositions of the luminescent layers are shown in table 1-1, the performances are shown in table 1-2, and the luminance efficiency trends of the devices as the current density increases are shown in FIGS. 10, 11 and 12, respectively.

The results of these Examples clearly show that all the devices have the advantages of flat luminance efficiency as current density increases, high luminance efficiency and high color saturation with CIE x=0.64 and y=0.35. These Examples demonstrate that the central metallic ions in the organic metal chelate may have a valence of +2 or +3, and its ligands can be quinolinol or benzoquinolinol ligands.

### Example 12

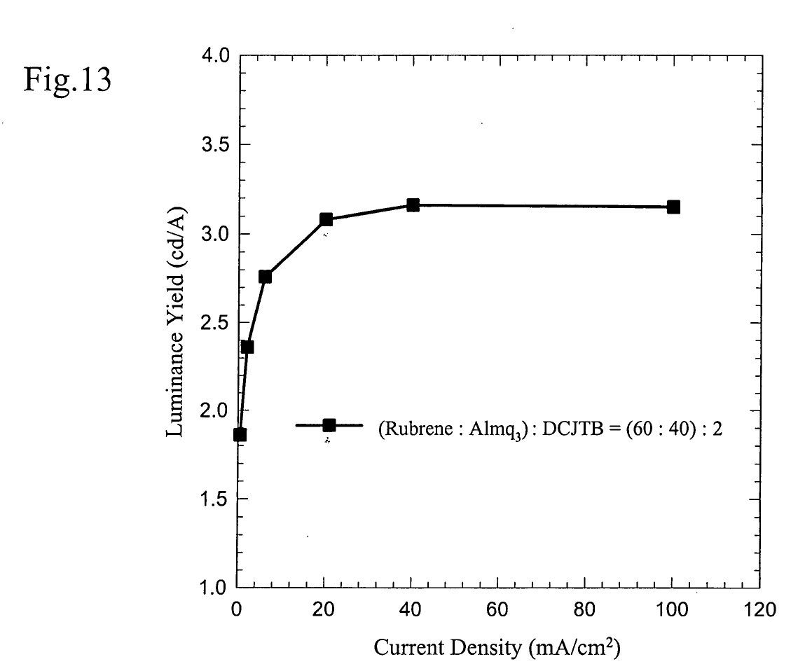

The structure and preparation procedures of the organic EL device were the same as those in Example 2, except that the ligands in the organic metal chelate in the luminescent layer were substituted methyl-quinolinol ligands. The composition of the luminescent layer is shown in table 1-1, the performance is shown in table 1-2, and the luminance efficiency trend of the device as the current density increases is shown in FIG. 13.

The results of this Example clearly show that the device has the advantages of flat luminance efficiency as current density increases, high luminance efficiency and high color saturation with CIE x=0.64 and y=0.35. This Example demonstrates that the ligands of the organic metal chelate of the invention can be substituted or unsubstituted.

### Example 13

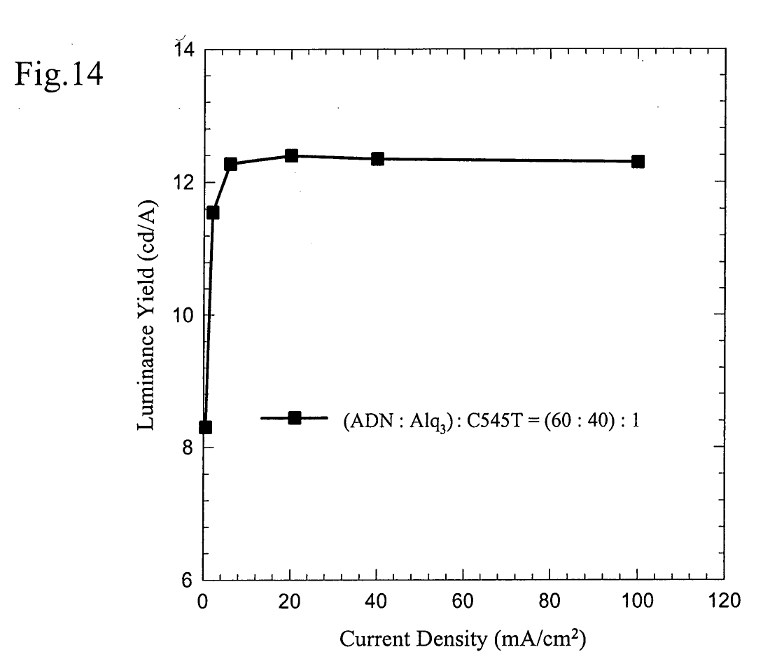

The structure and preparation procedures of the organic EL device were the same as those in Example 6, except that the luminescent dye guest emitter in the luminescent layer was C545T emitting green light at 524 run. The composition of the luminescent layer is shown in table 1-1, the performance is shown in table 1-2, and the luminance efficiency trend of the device as the current density increases is shown in FIG. 14.

The results of this Example clearly show that the device has the advantages of flat luminance efficiency as current density increases and high luminescent efficiency. This Example demonstrates that the luminescent dye guest emitter according to the present invention can be selected from, in addition to dyes emitting red light, dyes emitting green light.

### Example 14

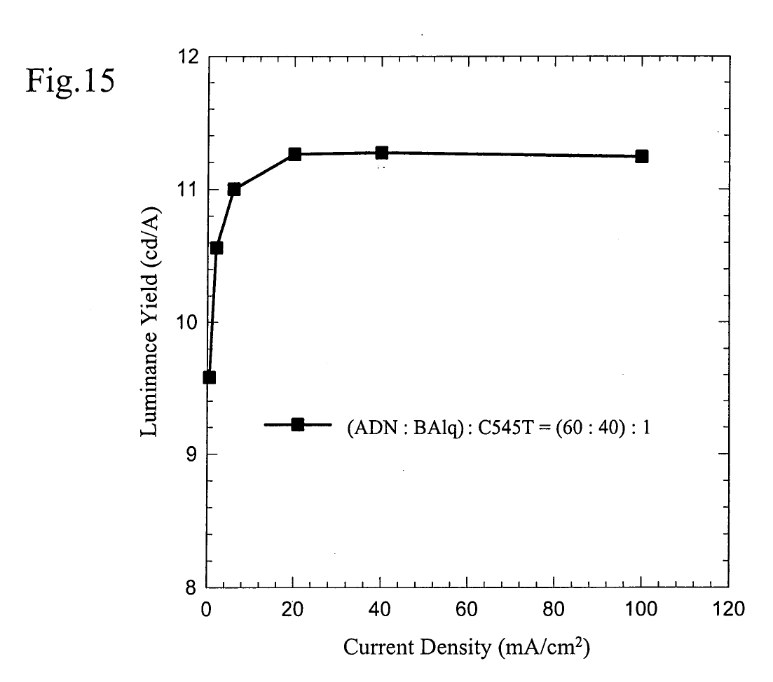

The structure and preparation procedures of the organic EL device were the same as those in Example 13, except that the organic metal chelate in the luminescent layer was BAlq comprising two identical nitrogen-containing quinolinol ligands and one nitrogen-free substituted phenol ligand. The composition of the luminescent layer is shown in table 1-1, the performance is shown in table 1-2, and luminance efficiency trend of the device as the current density increases is shown in FIG. 15.

The results of this Example clearly show that the device has the advantages of flat luminance efficiency as current density increases and high luminance efficiency. This Example demonstrates that the ligands of the organic metal chelate can either contain nitrogen or be nitrogen-free.

### Example 15

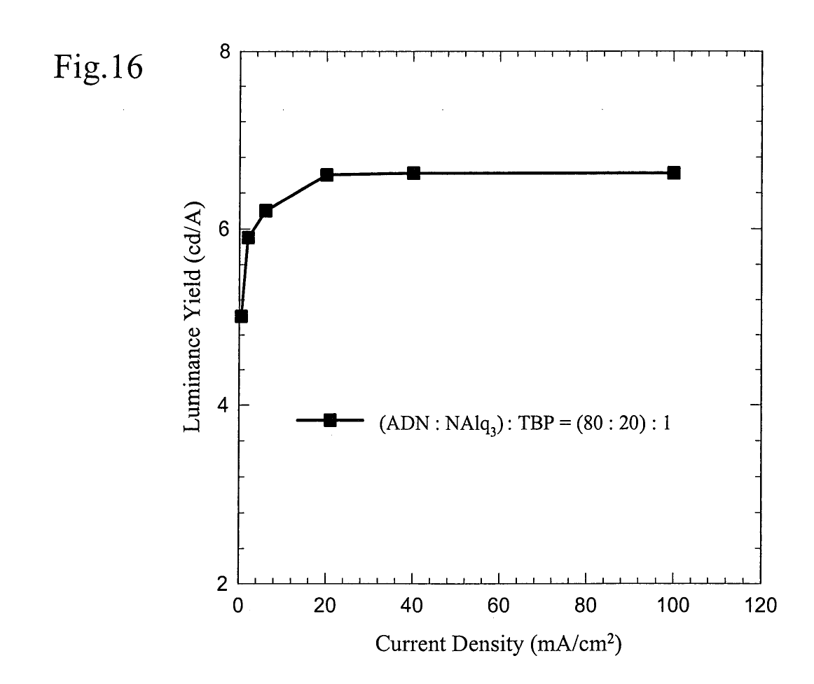

The structure and preparation procedures of the organic EL device were the same as those in Example 6, except that the ligand in the organic metal chelate in the luminescent layer was a ligand containing two nitrogen atoms, and the luminescent dye guest emitter was TBP emitting blue light at 470 nm. The composition of the luminescent layer is shown in table 1-1, the performance is shown in table 1-2, and the luminance efficiency trend of the device as current density increases is shown in FIG. 16.

The results of this Example clearly show that the device has the advantages of flat luminance efficiency as current density increases and high luminance efficiency. This Example demonstrates that the ligands of the organic metal chelate of the invention can either contain one nitrogen atom or contain more than one nitrogen atom. Further, the luminescent dye guest emitter can be selected from, in addition to dyes emitting red and green lights, dyes emitting blue light.

### Comparative Example 1

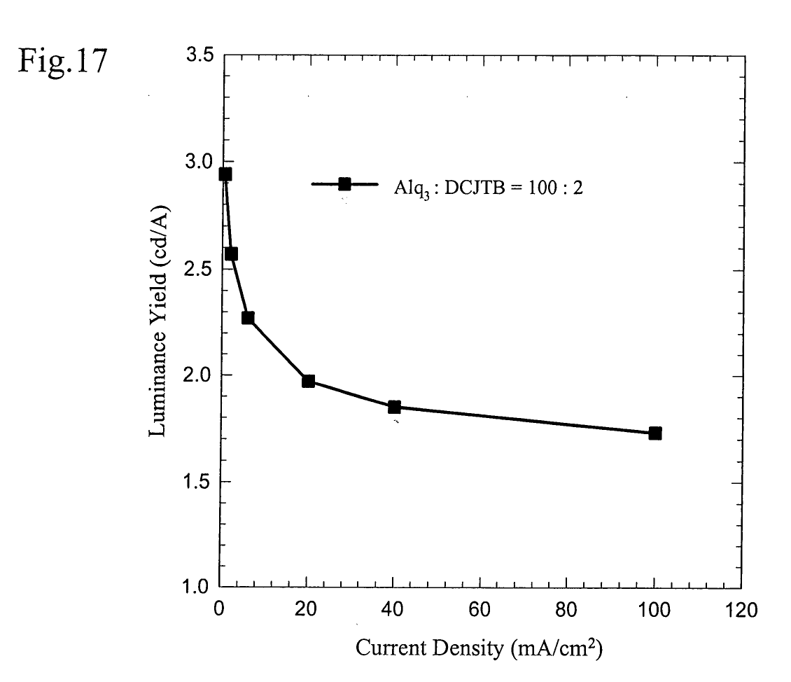

The structure and preparation procedures of the organic EL device were the same as those in Example 2, except that the luminescent layer was prepared by mixing the organic metal chelate Alq₃ and the luminescent dye DCJTB at a host to dopant weight ratio of (100): 2, without adding a condensed polycyclic aromatic compound. That is, the host emitter does not include a condensed polycyclic aromatic compound. The composition of the luminescent layer is shown in table 1-1, the performance is shown in table 1-2, and the luminance efficiency trend of the devices as the current density increases is shown in FIG. 17.

The results of Comparative Example 1 clearly show that the luminance efficiency of the device shows a significant downward trend as the current density rises, and the luminance efficiency is greatly reduced in comparison with Example 2. This Comparative Example demonstrates that the condensed polycyclic aromatic compound is an essential component of the luminescent layer according to the present invention.

### Comparative Example 2

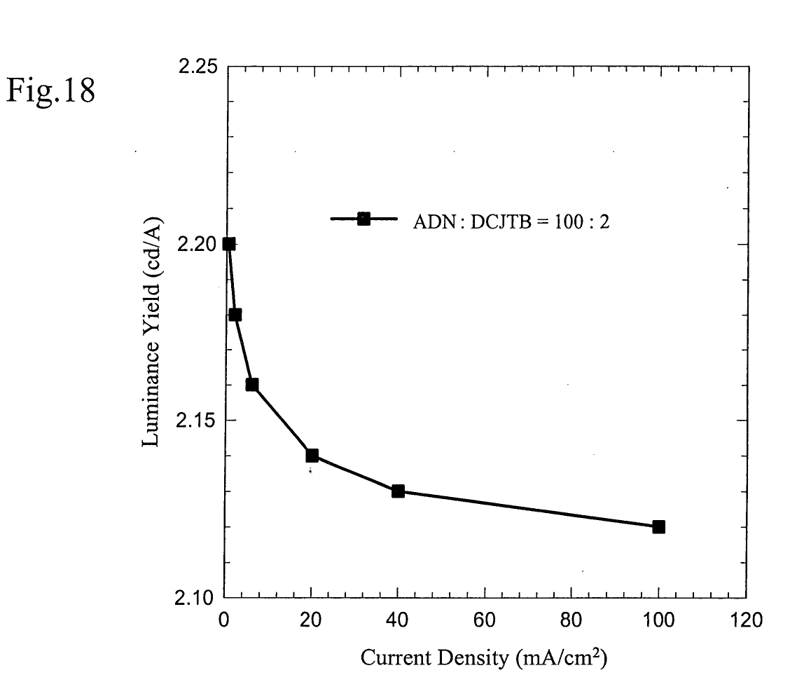

The structure and preparation procedures of the organic EL device were the same as those in Example 6, except that the luminescent layer was prepared by mixing the condensed polycyclic aromatic compound ADN and the luminescent dye DCJTB at a host to dopant weight ratio of (100):2, without adding an organic metal chelate. The composition of the luminescent layer is shown in table 1-1, the performance is shown in table 1-2, and the luminance efficiency trend of the device as current density increases is shown in FIG. 18.

The results of Comparative Example 2 clear show that the luminance efficiency of the device shows a significant downward trend as the current density rises, and the luminance efficiency is greatly reduced in comparison with Example 6. The color of the light emitted was orange with CIE coordinates (0.59, 0.39) instead of the saturated pure red with CIE coordinates (0.64, 0.35) in Example 6. This Comparative Example demonstrates that the organic metal chelate is an essential component of the luminescent layer according to the present invention.

### Comparative Example 3

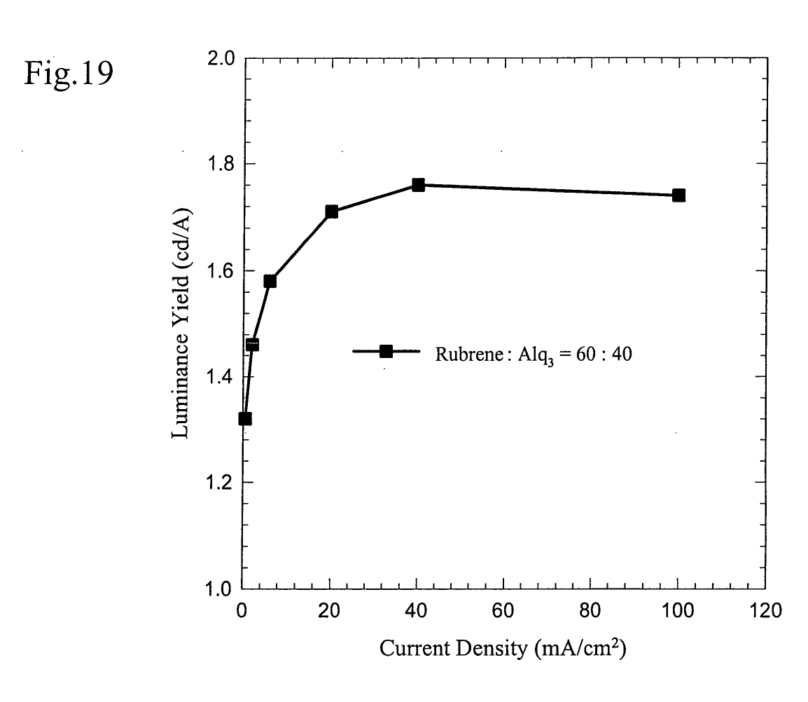

The structure and preparation procedures of the organic EL device were the same as those in Example 2, except that the luminescent layer was prepared by mixing the condensed polycyclic aromatic compound rubrene and the organic metal chelate Alq₃ at a weight ratio of 60:40, without adding a luminescent dye. The composition of the luminescent layer is shown in table 1-1, the performance is shown in table 1-2, and the luminance efficiency trend of the device as current density increases is shown in FIG. 19.

The results of Comparative Example 3 clearly show that the luminance efficiency of the device shows a significant downward trend as the current density rises, and the luminance efficiency is greatly reduced in comparison with Example 2. The color of the light emitted was orange with CIE coordinates (0.51, 0.47) instead of the saturated pure red with CIE coordinates (0.64, 0.35) in Example 2. This Comparative Example demonstrates that the luminescent dye is an essential component of the luminescent layer according to the present invention.

### Comparative Example 4

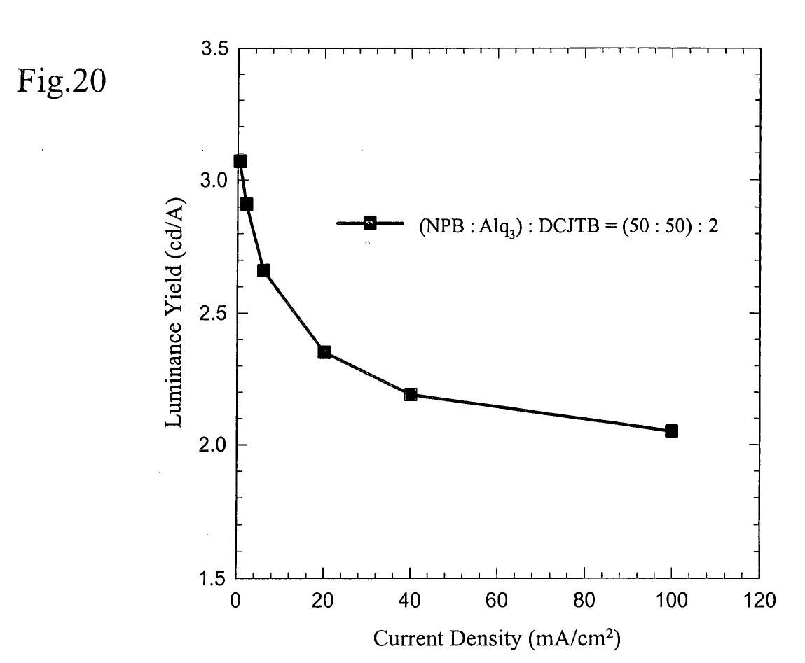

The structure and preparation procedures of the organic EL device were the same as those in Example 2, except that the condensed polycyclic aromatic compound used in the luminescent layer was a non-condensed polycyclic aromatic compound, NPB. The composition of the luminescent layer is shown in table 1-1, the performance is shown in table 1-2, and the luminance efficiency trend of the device as current density increases is shown in FIG. 20.

The results of Comparative Example 4 clearly show that the luminance efficiency of the device shows a significant downward trend as the current density rises, and the luminance efficiency is greatly reduced in comparison with Example 2. This Comparative Example demonstrates that the polycyclic aromatic compound used according to the present invention must be a condensed polycyclic aromatic compound.

### Comparative Example 5

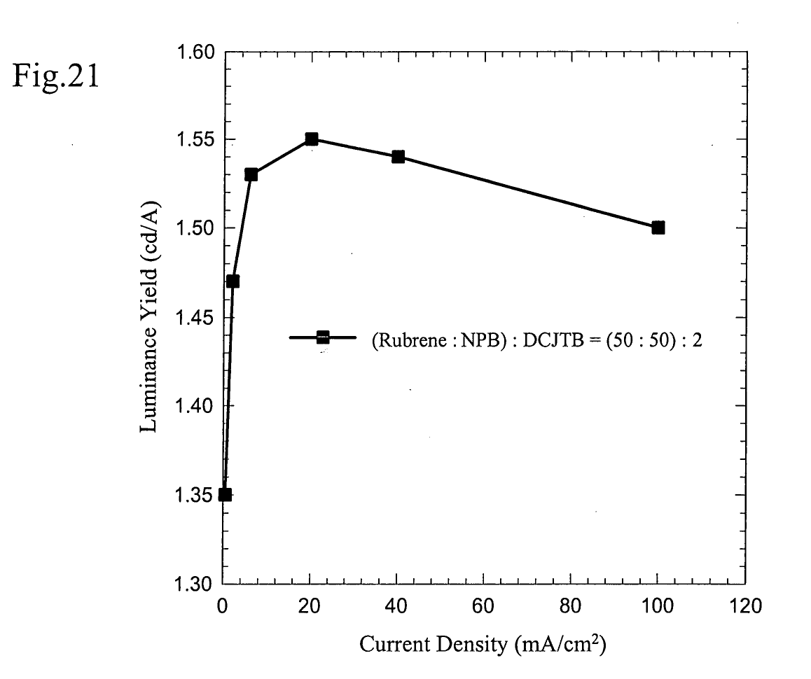

The structure and preparation procedures of the organic EL device were the same as those in Example 2, except that the organic metal chelate used in the luminescent layer was an inorganic metal chelate, NPB. The composition of the luminescent layer is shown in table 1-1, the performance is shown in table 1-2, and the luminance efficiency trend of the devices as current density increases is shown in FIG. 21.

The results of Comparative Example 5 clearly show that the luminance efficiency of the device shows a significant downward trend as the current density rises, and the luminance efficiency is greatly reduced as compared with Example 2. The color of the light emitted was orange with CIE coordinates (0.59, 0.40) instead of the saturated pure red with CIE coordinates (0.64, 0.35) in Example 2. This Comparative Example demonstrates that the metal chelate used according to the present invention must be an organic metal chelate.

### Comparative Example 6

This Comparative Example compares the hole mobilities of rubrene and its derivative, TTB-Rb. TTB-Rb is based on rubrene and further has four tert-butyl groups having four carbon atoms. The chemical structure of TTBRb is of the formula:

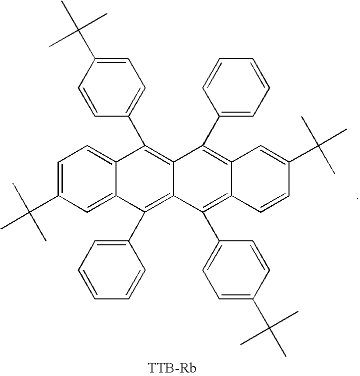

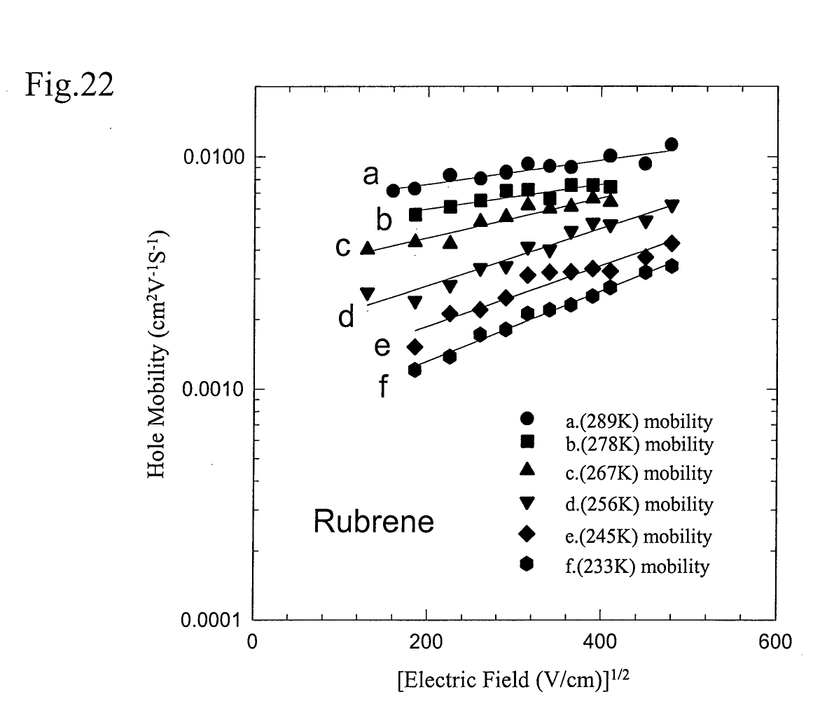

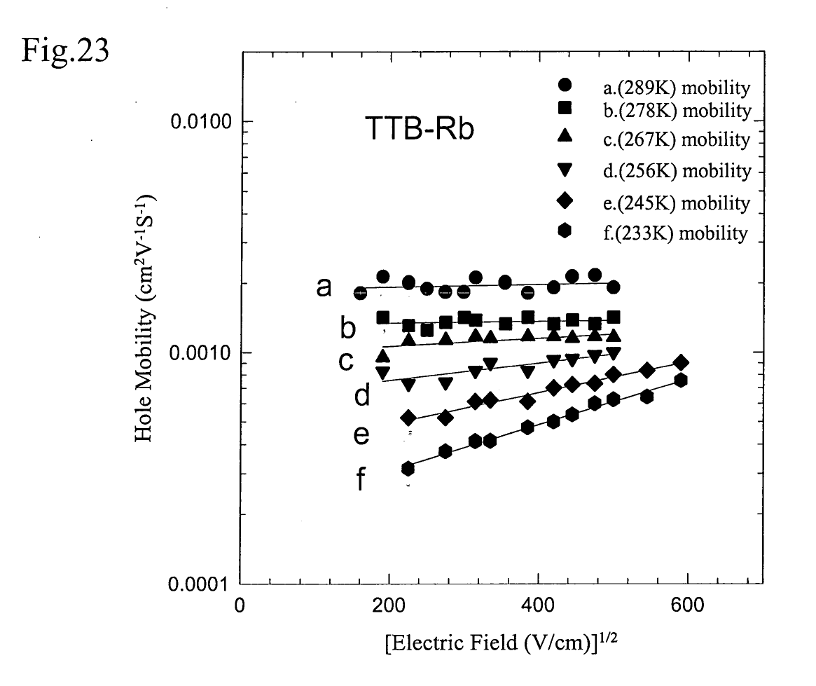

FIGS. 22 and 23 are the distributions of the hole mobilities of rubrene and TTB-Rb under different electric fields, respectively. When the substituting group of a substituted condensed polycyclic aromatic compound was a larger steric hindering group such as tert-butyl with four carbon atoms, the carrier mobility of the substituted condensed polycyclic aromatic compound was lower than that of the corresponding unsubstituted condensed polycyclic aromatic compound by an order of magnitude.

### Comparative Example 7

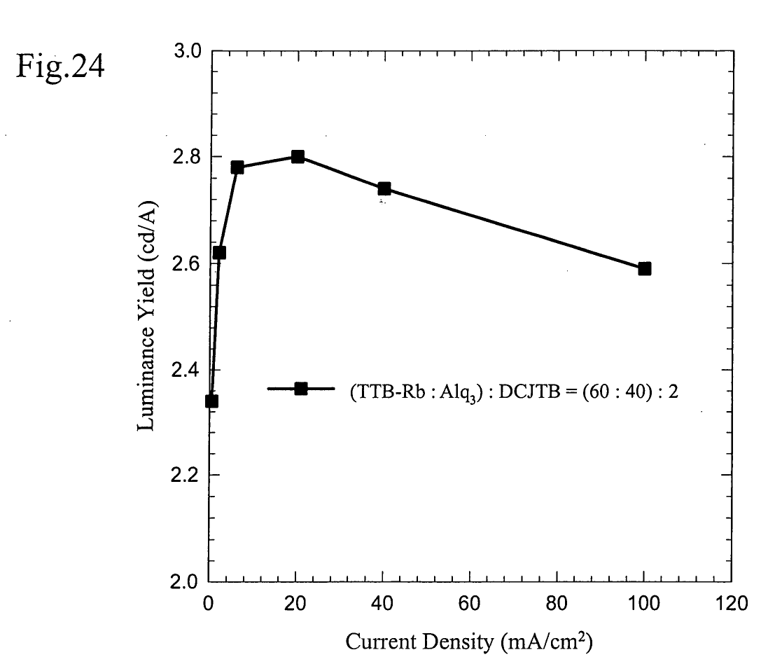

The structure and preparation procedures of the organic EL device were the same as those in Example 2, except that the condensed polycyclic aromatic compound used in the luminescent layer was the substituted condensed polycyclic aromatic compound TTB-Rb having four tert-butyl groups instead of the unsubstituted condensed polycyclic aromatic compound rubrene. The composition of the luminescent layer is shown in table 1-1, the performance is shown in table 1-2, and the luminance efficiency trend of the device as the current density increases is shown in FIG. 24.

The results of Comparative Example 7 clearly show that the luminance efficiency of the device shows a significant downward trend as the current density rises, and the luminance efficiency is greatly reduced in comparison with Example 2. This Comparative Example demonstrates that the condensed polycyclic aromatic compound according to the present invention is suitably an unsubstituted condensed polycyclic aromatic compound or a substituted condensed polycyclic aromatic compound with small sized substituting groups having less than four carbon atoms.

### Comparative Example 8

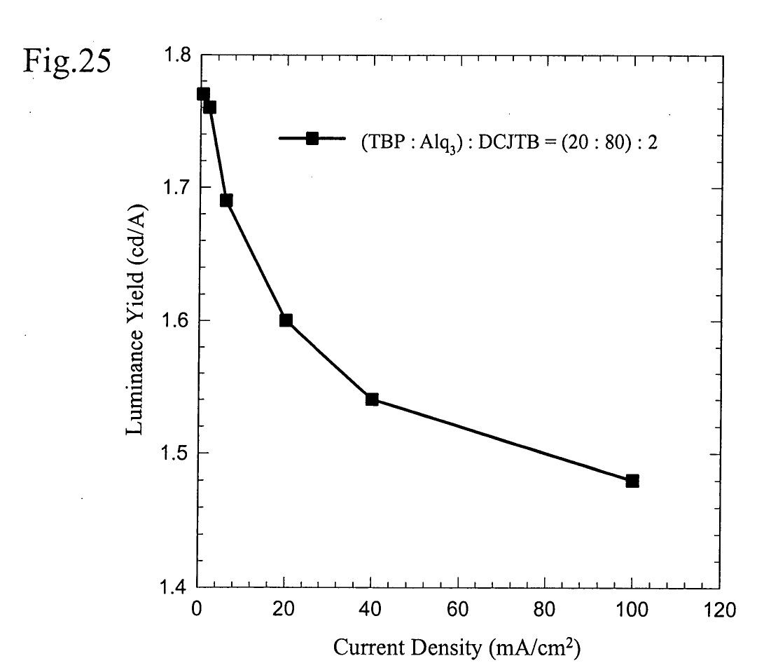

The structure and preparation procedures of the organic EL device were the same as those in Example 3, except that the condensed polycyclic aromatic compound used in the luminescent layer was the substituted condensed polycyclic aromatic compound TBP having four tert-butyl groups. The composition of the luminescent layer is shown in table 1-1, the performance is shown in table 1-2, and the luminance efficiency trend of the device as the current density increases is shown in FIG. 25.

According to the results, the luminance efficiency of the device shows a significant downward trend as the current density rises, and the luminance efficiency is greatly reduced in comparison with Example 3. This Comparative Example demonstrates that the condensed polycyclic aromatic compound according to the present invention is suitably an unsubstituted condensed polycyclic aromatic compound or a substituted condensed polycyclic aromatic compound with small sized substituting groups having less than four carbon atoms.

### Comparative Examples 2 and 10

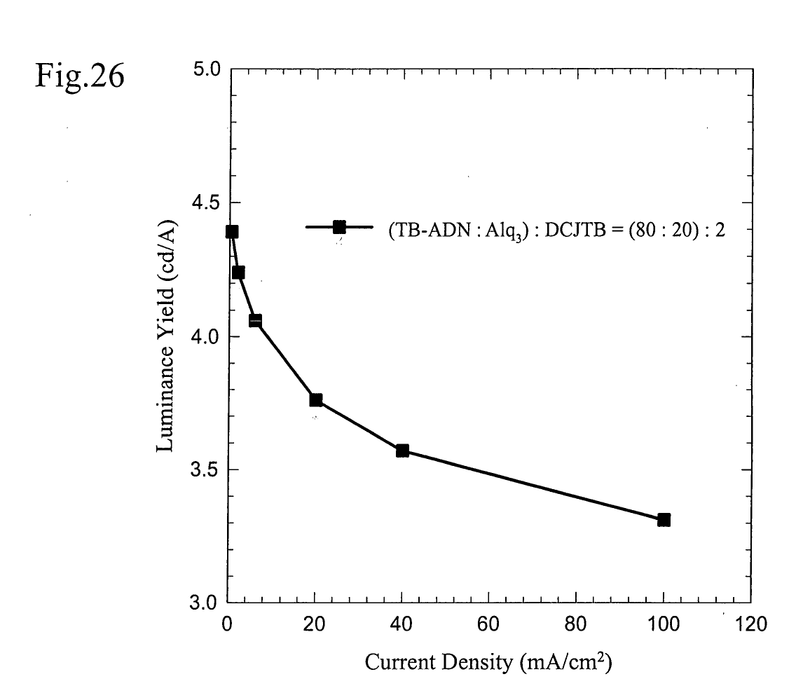

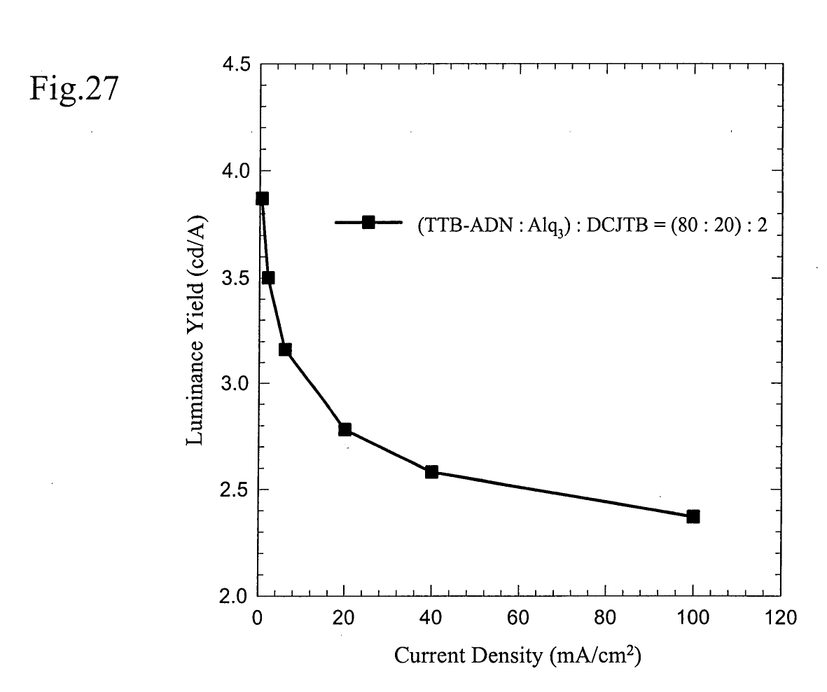

The structures and preparation procedures of the organic EL device were the same as those in Example 6, except that the condensed polycyclic aromatic compound used in the luminescent layer was changed to the substituted condensed polycyclic aromatic compound TB-ADN having one tert-butyl group and TTB-ADN having four tert-butyl groups, respectively. The chemical structures of TB-ADN and TTB-ADN are as show below. The compositions of the luminescent layer are shown in table 1-1, the performances are shown in table 1-2, and the luminance efficiency trends of the devices as the current density increases are shown in FIGS. 26 and 27, respectively.

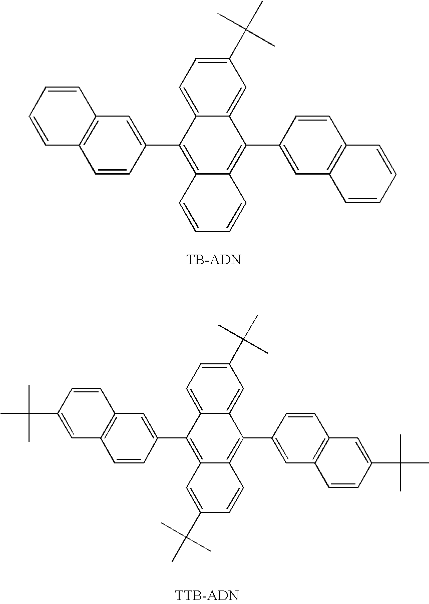

The results of Comparative Examples 9 and 10 clearly show that the luminance efficiencies of the devices show significant downward trends as the current density rises, and the luminance efficiencies are greatly reduced in comparison with Example 6. These Comparative Examples demonstrate that the condensed polycyclic aromatic compound according to the present invention is suitably an unsubstituted condensed polycyclic aromatic compound or a substituted condensed polycyclic aromatic compound with small sized substituting groups having less than four carbon atoms.

TABLE 1-1

| | Composition of luminescent layer | | | |
|---|---|---|---|---|
| | Condensed | | | |
| | polycyclic | | | |
| | aromatic | Organic metal | Luminescent | |
| | compound | chelate | dye | ((A):(B)):(C) |
| | (A) | (B) | (C) | (weight ratio) |
| Example 1 | Rubrene | Alq₃ | DCJTB | (40:60):2 |
| Example 2 | Rubrene | Alq₃ | DCJTB | (60:40):2 |
| Example 3 | Perylene | Alq₃ | DCJTB | (20:80):2 |
| Example 4 | Pyrene | Alq₃ | DCJTB | (20:80):2 |
| Example 5 | DPA | Alq₃ | DCJTB | (40:60):2 |
| Example 6 | ADN | Alq₃ | DCJTB | (80:20):2 |
| Example 7 | MADN | Alq₃ | DCJTB | (80:20):2 |
| Example 8 | EADN | Alq₃ | DCJTB | (80:20):2 |
| Example 9 | Rubrene | Gaq₃ | DCJTB | (60:40):2 |
| Example 10 | Rubrene | Inq₃ | DCJTB | (60:40):2 |
| Example 11 | Rubrene | BeBq₂ | DCJTB | (60:40):2 |
| Example 12 | Rubrene | Almq₃ | DCJTB | (60:40):2 |
| Example 13 | ADN | Alq₃ | C545T | (60:40):1 |
| Example 14 | ADN | BAlq | C545T | (60:40):1 |
| Example 15 | ADN | NAlq₃ | TBP | (80:20):1 |
| Comparative example 1 | None | Alq₃ | DCJTB | (0:100):2 |
| Comparative example 2 | ADN | None | DCJTB | (100:0):2 |
| Comparative example 3 | Rubrene | Alq₃ | None | (60:40):0 |
| Comparative example 4 | NPB | Alq₃ | DCJTB | (50:50):2 |
| Comparative example 5 | Rubrene | NPB | DCJTB | (50:50):2 |
| Comparative example 6 | The measurement and comparison of the | | | |
| | hole mobilities of rubrene and TTBRb | | | |
| Comparative example 7 | TTBRb | Alq₃ | DCJTB | (60:40):2 |
| Comparative example 8 | TBP | Alq₃ | DCJTB | (20:80):2 |
| Comparative example 9 | TBADN | Alq₃ | DCJTB | (80:20):2 |
| Comparative example 10 | TTBADN | Alq₃ | DCJTB | (80:20):2 |

TABLE 1-2

| | Driving | Luminance | Luminance | CIE coordinates |
|---|---|---|---|---|
| | voltage (V) | (mA/cm²) | efficiency (cd/A) | x, y |
| Example 1 | 9.2 | 552 | 2.8 | 0.66, 0.34 |
| Example 2 | 6.8 | 888 | 4.5 | 0.65, 0.35 |
| Example 3 | 8.7 | 689 | 3.5 | 0.66, 0.35 |
| Example 4 | 7.9 | 575 | 2.8 | 0.67, 0.35 |
| Example 5 | 9.7 | 551 | 2.8 | 0.64, 0.35 |
| Example 6 | 10.4 | 926 | 4.7 | 0.64, 0.35 |
| Example 7 | 11.4 | 928 | 4.6 | 0.64, 0.35 |
| Example 8 | 11.8 | 912 | 4.5 | 0.64, 0.35 |
| Example 9 | 7.1 | 852 | 4.3 | 0.64, 0.35 |
| Example 10 | 8.3 | 786 | 4.0 | 0.64, 0.35 |
| Example 11 | 7.1 | 780 | 3.9 | 0.64, 0.35 |
| Example 12 | 8.8 | 598 | 3.1 | 0.64, 0.35 |
| Example 13 | 7.5 | 2836 | 14.2 | 0.32, 0.64 |
| Example 14 | 8.6 | 2253 | 11.3 | 0.36, 0.61 |
| Example 15 | 8.9 | 1311 | 6.6 | 0.13, 0.21 |
| Comparative example 1 | 9.2 | 395 | 2.0 | 0.64, 0.35 |
| Comparative example 2 | 9.4 | 428 | 2.1 | 0.59, 0.39 |
| Comparative example 3 | 7.8 | 342 | 1.7 | 0.51, 0.47 |
| Comparative example 4 | 12.0 | 469 | 2.4 | 0.62, 0.37 |
| Comparative example 5 | 8.7 | 310 | 1.6 | 0.59, 0.40 |
| Comparative example 6 | See FIGS. 22 and 23. | | | |
| Comparative example 7 | 12.5 | 561 | 2.8 | 0.63, 0.36 |
| Comparative example 8 | 11.1 | 320 | 1.6 | 0.63, 0.36 |
| Comparative example 9 | 11.1 | 700 | 3.5 | 0.63, 0.37 |
| Comparative example 10 | 10.4 | 599 | 3.1 | 0.59, 0.39 |

### Parts List

10 organic el device

11 glass or plastic substrate

12 anode

13 hole-injecting layer

14 hole-transporting layer

15 luminescent layer

16 electron-transporting layer

17 electron-injecting layer

18 cathode

19 power source

What is claimed is:

1. An organic electroluminescent device comprising a pair of electrodes and at least one luminescent layer interposed between the pair of electrodes, the luminescent layer comprising a condensed polycyclic aromatic compound which is unsubstituted or substituted by C₁-C₃alkyl, C₂-C₃alkenyl, C₁-C₃alkoxy or cyano groups; an organic metal chelate; and a luminescent dye.

2. An organic electroluminescent device according to claim 1, wherein the condensed polycyclic aromatic compound in the luminescent layer is of the formula 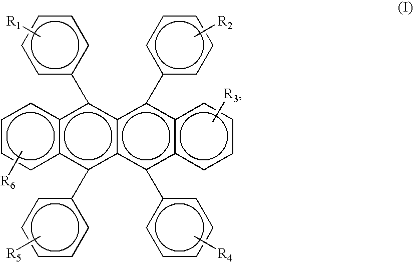
wherein R₁ to R₆ independently represtent hydrogen, C₁-C₃alkyl, C₂-C₃alkenyl, C₁-C₃alkoxy or cyano groups.

3. An organic electroluminescent device according to claim 1, the condensed polycyclic aromatic compound in the luminescent layer is of the formula 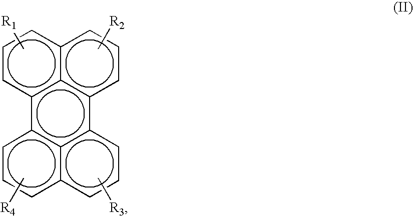
wherein R₁ to R₄ independently represent hydrogen, C₁-C₃alkyl, C₂-C₃alkenyl, C₁-C₃alkoxy or cyano groups.

4. An organic electroluminescent device according to claim 1, the component (A) in the luminescent layer is of the formula 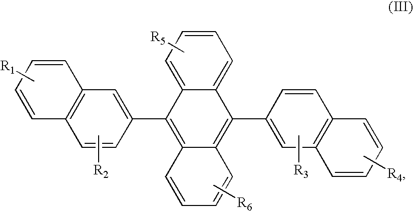
wherein R₁ to R₆ independently represent hydrogen, C₁-C₃alkyl, C₂-C₃alkenyl, C₁-C₃alkoxy or cyano groups.

5. An organic electroluminescent device according to claim 1, the condensed polycyclic aromatic compound in the luminescent layer is of the formula 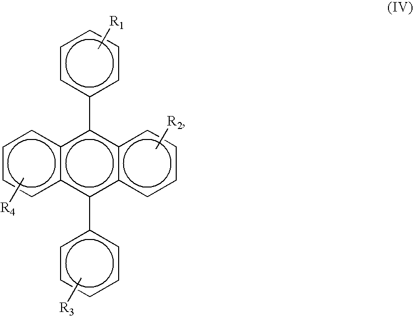
wherein R₁ to R₄ independently represent hydrogen, C₁-C₃alkyl, C₂-C₃alkenyl, C₁-C₃alkoxy or cyano groups.

6. An organic electroluminescent device according to claim 1, the condensed polycyclic aromatic compound in the luminescent layer is of the formula 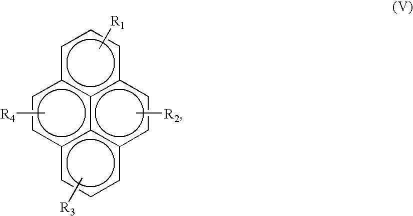
wherein R₁ to R₄ independently represent hydrogen, C₁-C₃alkyl, C₂-C₃alkenyl, C₁-C₃alkoxy or cyano groups.

7. An organic electroluminescent device according to claim 1, wherein the condensed polycyclic aromatic compound in the luminescent layer is rubrene, perylene, ADN, MADN, EADN, DPA or pyrene.

8. An organic electroluminescent device according to claim 1, wherein the organic metal chelate in the luminescent layer is an organic metal chelate comprising one or more ligands containing one or more than one nitrogen atom.

9. An organic electroluminescent device according to claim 1, the organic metal chelate in the luminescent layer is of the following general formula (VI):
M-XₘYₙ (VI),
wherein M signifies a metal with a valence of 2 or 3; X signifies a ligand containing one or more than one nitrogen atom; Y signifies a nitrogen-free ligand; m is 2 or 3, n is 0, 1 or 2, and m+n is 2 or 3.

10. An organic electroluminescent device according to claim 9, the ligand X of the organic metal chelate in the luminescent layer is of any one of the formulae 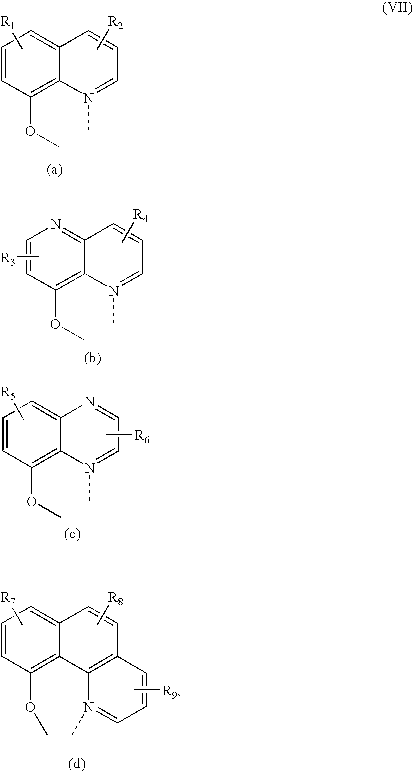
wherein R₁ to R₉ independently represent hydrogen or any substituting groups.

11. An organic electroluminescent device according to claim 1, wherein the organic metal chelate in the luminescent layer is Alq₃, BeBq₂, Inq₃, Gaq₃, Almq₃, BAlq or NAlq₃.

12. A organic electroluminescent device according to claim 1, wherein the weight ratio of condensed polycyclic aromatic compound to organic metal chelate is from 20:80 to 80:20.

13. An organic electroluminescent device according to claim 1, wherein the bandgap energy of the luminescent dye is less than those of the condensed polycyclic aromatic compound and the organic metal chelate in the luminescent layer.

14. An organic electroluminescent device according to claim 1, wherein the luminance range of the luminescent dye in the luminescent layer is between 440 nm and 700 nm.

15. An organic electroluminescent device according to claim 1, wherein the chemical structure of the luminescent dye is of formula 1, 2 or 3, 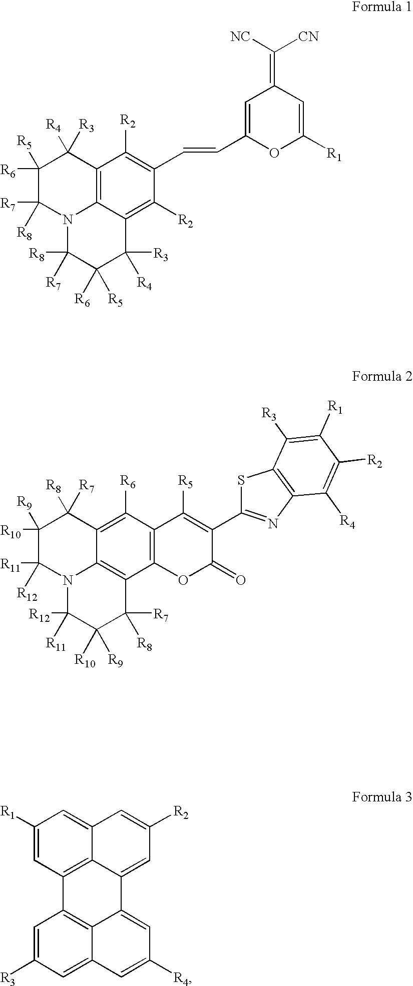
wherein R₁ to R₁₂ independently represent hydrogen or any substituting groups.
